(19) United States
(12) Patent Application Publication
(10) Pub. No.: US 2019/0309193 A1
(43) Pub. Date: Oct. 10, 2019

(54) POLARIZING FILM WITH ADHESIVE LAYER AND METHOD FOR PRODUCING SAID POLARIZING FILM WITH ADHESIVE LAYER

(71) Applicant: NITTO DENKO CORPORATION, Ibaraki-shi, Osaka (JP)

(72) Inventors: Yasuaki Okada, Ibaraki-shi (JP); Takeshi Saito, Ibaraki-shi (JP); Keisuke Kimura, Ibaraki-shi (JP); Tetsuro Ikeda, Ibaraki-shi (JP)

(73) Assignee: NITTO DENKO CORPORATION, Ibaraki-shi, Osaka (JP)

(21) Appl. No.: 16/314,929

(22) PCT Filed: Jun. 26, 2017
(86) PCT No.: PCT/JP2017/023366

§ 371 Date: Jan. 3, 2019

(30) Foreign Application Priority Data
Jul. 8, 2016 (JP) 2016-135691
Jun. 20, 2017 (JP) 2017-120100

(51) Int. Cl. C09J 7/38; G02B 1/14; G02B 5/30; C09J 11/04

(52) U.S. Cl. CPC C09J 7/38; G02B 1/14; C09J 2205/31; C09J 11/04; G02B 5/30

(57) ABSTRACT

A pressure-sensitive-adhesive layer attached polarizing film comprises a polarizing film in which a transparent protective film is laid on/over at least one surface of a polarizer to interpose an adhesive layer between the surface and the transparent protective film, and a pressure-sensitive-adhesive layer laminated on a transparent protective film side of the polarizing film. The adhesive-layer-laid surface of the polarizer is subjected to an activating treatment. The adhesive layer is a cured product layer of an adhesive composition. The adhesive composition comprises an active-energy-ray-curable component, and a shrinkage inhibitor having a structural formula having an M-O bond wherein M is silicon, titanium, aluminum or zirconium, and O represents an oxygen atom.

### TECHNICAL FIELD

The present invention relates to a pressure-sensitive-adhesive layer attached polarizing film including a polarizing film in which a transparent protective film is laid on/over at least one surface of a polarizer to interpose an adhesive layer between the surface and the transparent protective film, and a pressure-sensitive-adhesive layer laminated on a transparent protective film side of the polarizing film; and a method for producing this pressure-sensitive-adhesive layer attached polarizing film. The pressure-sensitive-adhesive layer attached polarizing film is usable alone or in the form of laminating this film to an optical film to form an image display such as a liquid crystal display (LCD), an organic EL display, a CRT or a PDP.

### BACKGROUND ART

In watches, portable telephones, PDAs, notebook PCs, monitors for personal computers, DVD players, TVs and others, liquid crystal displays have been rapidly developing in the market. A liquid crystal display is a device making the state of polarized light visible by switching of a liquid crystal. In light of the display principle thereof, a polarizer is used. In particular, TVs and other articles have been increasingly required to be higher in brightness and contrast, and wider in viewing angle. Their polarizing film has also been increasingly required to be higher in transmittance, polarization degree, color reproducibility, and others.

As a polarizer, an iodine-based polarizer has been most popularly and widely used, which has a structure obtained by adsorbing iodine onto, for example, a polyvinyl alcohol (hereinafter also referred to merely as a “PVA”), and then stretching the resultant since the polarizer is high in transmittance and polarization degree. A generally used polarizing film is a polarizing film in which transparent protective films are bonded, respectively, onto both surfaces of a polarizer through the so-called water-based adhesive, in which a polyvinyl alcohol-based material is dissolved in water (Patent Document 1 listed below). For the transparent protective films, for example, triacetylcellulose is used, which has a high moisture permeability. In the case of the use of the water-based adhesive (the so-called wet lamination), a drying step is required after the transparent protective films are bonded to the polarizer.

Instead of the water-based adhesive, an active-energy-ray-curable adhesive is suggested. When the active-energy-ray-curable adhesive is used to produce polarizing films, no drying step is required. Thus, the polarizing films can be improved in producibility. Suggested is, for example, a radical-polymerizing type active-energy-ray-curable adhesive composition, using an N-substituted amide monomer as a curable component (Patent Document 2 listed below). This adhesive composition is a composition exhibiting an excellent endurance in a severe environment of a high humidity and a high temperature. However, in the market in the actual circumferences, the adhesive composition is being required to be further improvable in adhesion and/or water resistance.

Apart from the above, Patent Document 3 listed below describes a method for producing a polarizing plate that includes the step of applying an activating treatment to an adhesive-layer-laying-planned surface of a polarizer to heighten the adhering strength between the polarizer and a transparent protective film.

### PRIOR ART DOCUMENTS

### Patent Documents

Patent Document 1: JP-A-2006-220732

Patent Document 2: JP-A-2008-287207

Patent Document 3: Japanese Patent No. 4744483

### SUMMARY OF THE INVENTION

### Problems to be Solved by the Invention

However, the inventors have made eager investigations to find that according to the technique described in Patent Document 3, it is difficult to restrain the polarizing plate from being shrunken and, in particular, to restrain the polarizing plate from being shrunken in a severe environment of a high humidity and a high temperature.

In the light of the actual circumstances, the present invention has been developed. An object thereof is to provide a pressure-sensitive-adhesive layer attached polarizing film that can be restrained from being shrunken in a severe condition such as a dew condensation environment; and a method for producing the polarizing film.

### Means for Solving the Problems

In order to solve the above-mentioned problem, the inventors have repeatedly made eager investigations to find out that the object can be attained by a curable adhesive composition described below. Thus, the present invention has been solved.

The present invention relates to a pressure-sensitive-adhesive layer attached polarizing film, including a polarizing film in which a transparent protective film is laid on/over at least one surface of a polarizer to interpose an adhesive layer between the surface and the transparent protective film; and a pressure-sensitive-adhesive layer laminated on a transparent protective film side of the polarizing film; in which the adhesive-layer-laid surface of the polarizer is subjected to an activating treatment; the adhesive layer is a cured product layer of an adhesive composition; the adhesive composition includes an active-energy-ray-curable component, and a shrinkage inhibitor having a structural formula having an M-O bond in which M is silicon, titanium, aluminum or zirconium, and O represents an oxygen atom; and a maximum dimension change ratio defined by the following is 0.40% or less:

“maximum dimension change ratio”=“a maximum dimension change ratio out of respective dimension change ratios in an MD direction and a TD direction of the pressure-sensitive-adhesive layer attached polarizing film, these ratios being measured after the pressure-sensitive-adhesive layer attached polarizing film is allowed to stand still in an environment of 80° C. temperature for 500 hours, and respective dimension change ratios in the MD direction and the TD direction of the pressure-sensitive-adhesive layer attached polarizing film, these ratios being measured after the pressure-sensitive-adhesive layer attached polarizing film is allowed to stand still in an environment of 60° C. temperature and 90% humidity for 500 hours”.

It is preferred in the pressure-sensitive-adhesive layer attached polarizing film that the shrinkage inhibitor is an organosilicon compound.

It is preferred in the pressure-sensitive-adhesive layer attached polarizing film that the shrinkage inhibitor is at least one organometallic compound selected from the group consisting of metal alkoxides, and metal chelates.

It is preferred in the pressure-sensitive-adhesive layer attached polarizing film that the organometallic compound is at least one selected from the group consisting of titanium acylates, titanium alkoxides, and titanium chelates.

It is preferred in the pressure-sensitive-adhesive layer attached polarizing film that when a total amount of the active-energy-ray-curable component is regarded as 100 parts by weight, a proportion of the shrinkage inhibitor is from 0.05 to 9 parts by weight.

It is preferred in the pressure-sensitive-adhesive layer attached polarizing film that the shrinkage inhibitor includes an organic group, and the organic group has 3 or more carbon atoms.

It is preferred in the pressure-sensitive-adhesive layer attached polarizing film that the transparent protective film has a moisture permeability of 5 to 70 g/m².

It is preferred in the pressure-sensitive-adhesive layer attached polarizing film that the polarizing film has a thickness of 100 μm or less.

The present invention also relates to a method for producing a pressure-sensitive-adhesive layer attached polarizing film, including a polarizing film in which a transparent protective film is laid on/over at least one surface of a polarizer to interpose an adhesive layer between the surface and the transparent protective film, and a pressure-sensitive-adhesive layer laminated on a transparent protective film side of the polarizing film; including the following: a step of subjecting an adhesive-layer-laying-planned surface of the polarizer to an activating treatment; an applying step of applying an adhesive composition including an active-energy-ray-curable component, and a shrinkage inhibitor having a structural formula having an M-O bond in which M is silicon, titanium, aluminum or zirconium, and O represents an oxygen atom to a surface of at least one of the polarizer and the transparent protective film; a bonding step of bonding the polarizer and the transparent protective film to each other; an adhering step of radiating an active energy ray to the resultant workpiece from a polarizer surface side of the workpiece or a transparent protective film surface side of the workpiece to cure the adhesive composition to yield the adhesive layer, and causing the polarizer and the transparent protective film to adhere to each other through the yielded adhesive layer; and a step of forming the pressure-sensitive-adhesive layer on/over a surface of the transparent protective film that is opposite to the adhesive-layer-laminated surface of the transparent protective film.

It is preferred in the method for producing a pressure-sensitive-adhesive layer attached polarizing film that the shrinkage inhibitor is an organosilicon compound.

It is preferred in the method for producing a pressure-sensitive-adhesive layer attached polarizing film that the shrinkage inhibitor is at least one organometallic compound selected from the group consisting of metal alkoxides, and metal chelates.

### Effect of the Invention

In the present invention, as a polarizer, a polarizer is used which has an adhesive-layer-laid surface subjected to an activating treatment (requirement 1). An adhesive composition for forming the adhesive layer includes a specified shrinkage inhibitor (requirement 2). Furthermore, the maximum dimension change ratio of the pressure-sensitive-adhesive layer attached polarizing film, this ratio being measured under specified conditions, is set to 0.4% or less (requirement 3). In other words, requirements 1 to 3 are integrated with each other to be inseparable. It is not until these requirements are combined with each other that the problem of the invention of the present application can be solved. Although reasons therefor are unclear, the reasons can be presumed as follows:

About a pressure-sensitive-adhesive layer attached polarizing film equipped with at least a polarizer and a transparent protective film, a change in the dimension thereof is largely affected mainly by a change in the dimension of the polarizer. In other words, in order to restrain a change in the dimension of the pressure-sensitive-adhesive layer attached polarizing film, it is effective to restrain a change in the dimension of the polarizer. However, about a polarizer showing a small dimension change ratio, a sufficient crosslinked structure tends not to be formed therein. In a dew condensation environment or an environment in which the polarizer is put into hot water, the polarizer strongly tends to be shrunken. In the end, the pressure-sensitive-adhesive layer attached polarizing film tends to be increased in dimension change ratio in the dew condensation environment or the environment in which the polarizer is put into hot water.

In the present invention, as a polarizer, a polarizer is used which has an adhesive-layer-laid surface subjected to an activating treatment (requirement 1). When a surface of a polarizer is subjected to an activating treatment, the surface is turned into a plasticized state. When in this state the surface is coated with an adhesive composition including a specified shrinkage inhibitor (requirement 2), any component in the adhesive composition, particularly, the specified shrinkage inhibitor therein easily permeates the inside of the polarizer. When the shrinkage inhibitor permeates the inside of the polarizer, this inhibitor being an inhibitor having a structural formula having an M-O bond in which M is silicon, titanium, aluminum or zirconium and O represents an oxygen atom, polyvinyl alcohol (PVA) included in the polarizer is crosslinked. Thus, even in a dew condensation environment or an environment in which the pressure-sensitive-adhesive layer attached polarizing film is put into hot water, the polarizer itself is sufficiently restrained from being shrunken (requirement 3).

In the case of using, in the present invention, particularly, at least one organometallic compound selected from the group consisting of organosilicon compounds, metal alkoxides, and metal chelates as the shrinkage inhibitor, the polarizing film can be more effectively prevented from being shrunken.

In the case of using, particularly, at least one organometallic compound selected from the group consisting of metal alkoxides and metal chelates as the shrinkage inhibitor, a dramatic improvement can be made in the adhering strength between the transparent protective film and the polarizer. Thus, in a dew condensation environment or an environment in which the pressure-sensitive-adhesive layer attached polarizing film is put into hot water, the compatibility of the following with each other can be attained with a good balance: the adhering strength between the transparent protective film and the polarizer; and the restraint of the shrinkage of the pressure-sensitive-adhesive layer attached polarizing film. In the case of exposing, to a dew condensation environment, the pressure-sensitive-adhesive layer attached polarizing film, in which the transparent protective film is laminated to the polarizer to interpose the adhesive layer therebetween, a mechanism that adhesion peeling is generated, particularly, between the adhesive layer and the polarizer can be presumed as follows: Water that has permeated the protective film initially diffuses into the adhesive layer, and the water diffuses to the polarizer interfacial side of the pressure-sensitive-adhesive layer attached polarizing film. In any conventional pressure-sensitive-adhesive layer attached polarizing film, hydrogen bonding and/or ion bonding contribute(s) largely to the adhering strength between its adhesive layer and its polarizer. However, the water that has diffused to the polarizer interfacial side thereof causes the hydrogen bonding and the ion bonding at the interface to be dissociated. As a result, the adhering strength between the adhesive layer and the polarizer is lowered. In this way, adhesion peeling may be generated between the polarizer and the adhesive layer in a dew condensation environment.

In the meantime, when the adhesive composition includes, as a shrinkage inhibitor, at least one organometallic compound selected from the group consisting of metal alkoxides and metal chelates, this organometallic compound is turned to an active metallic species by aid of water. As a result, the organometallic compound interacts strongly with both of the polarizer, and the active-energy-ray-curable component included in the adhesive layer. In this way, even when water is present at the interface between the polarizer and the adhesive layer, these interacts strongly with each other through the organometallic compound, so that a dramatic improvement is made in adhesion water-resistance between the polarizer and the adhesive layer.

### MODE FOR CARRYING OUT THE INVENTION

The pressure-sensitive-adhesive layer attached polarizing film of the present invention is a pressure-sensitive-adhesive layer attached polarizing film including: a polarizing film in which a transparent protective film is laid on/over at least one surface of a polarizer to interpose an adhesive layer between the surface and the transparent protective film; and a pressure-sensitive-adhesive layer laminated on a transparent protective film side of the polarizing film. The adhesive-layer-laid surface of the polarizer is subjected to an activating treatment, and the adhesive layer is a cured product layer of an adhesive composition. This adhesive composition includes an active-energy-ray-curable component, and a shrinkage inhibitor having a structural formula having an M-O bond in which M is silicon, titanium, aluminum or zirconium, and O represents an oxygen atom. Furthermore, the pressure-sensitive-adhesive layer attached polarizing film of the invention is a film in which a maximum dimension change ratio defined by the following is 0.40% or less:

“maximum dimension change ratio”=“a maximum dimension change ratio out of respective dimension change ratios in an MD direction and a TD direction of the pressure-sensitive-adhesive layer attached polarizing film, these ratios being measured after the pressure-sensitive-adhesive layer attached polarizing film is allowed to stand still in an environment of 80° C. temperature for 500 hours, and respective dimension change ratios in the MD direction and the TD direction of the pressure-sensitive-adhesive layer attached polarizing film, these ratios being measured after the pressure-sensitive-adhesive layer attached polarizing film is allowed to stand still in an environment of 60° C. temperature and 90% humidity for 500 hours”.

Herein, the “MD direction” means the flowing direction of a resin which is a raw material of the film, that is, the machine direction thereof, and

the “TD direction” means the width direction of the resin, that is, the transverse direction thereof.

The thickness of the polarizing film according to the present invention is preferably 100 μm or less, more preferably 50 μm or less.

### <Polarizer Having Adhesive-Layer-Laid Surface Subjected to an Activating Treatment>

The activating treatment is at least one treatment selected from corona treatment, plasma treatment, glow treatment, and ozone treatment. The corona treatment may be conducted, for example, in the manner of using a corona treatment machine to discharge electricity in an ordinary-pressure air. The plasma treatment may be conducted, for example, in the manner of using a plasm discharging machine to discharge electricity in an ordinary-pressure air, or in the atmosphere of an inert gas such as nitrogen or argon. The glow treatment and the ozone treatment may each be conducted in an ordinary manner. Out of these treatments, the corona treatment is preferred since this treatment attains a treatment from the outer surface of a product to be treated down to a deeper site thereof than the plasma treatment and the glow treatment; thus, when the corona treatment is applied to, for example, a polarizer, the advantageous effect of the treatment can be attained down to the inside of the polarizer. The treatment down to the inside of the polarizer facilitates the shrinkage inhibitor in the present invention to diffuse into the polarizer. This matter can effectively produce the effect of restraining the shrinkage of the pressure-sensitive-adhesive layer attached polarizing film, which is an advantageous effect of the invention.

About the activating treatment, conditions for the treatment are set to make the polarizer into the above-mentioned surface state in accordance with the activating treatment. For example, in the corona treatment, the discharge quantity is from about 10 to 200 W/m²/min., preferably from about 20 to 150 W/m²/min. If the discharge power is low, the discharge treatment may not be uniformly conducted. If the discharge power is high, a local discharge is unfavorably generated so that a hole may be made in the surface of the film.

The polarizer is not particularly limited, and may be of various types. The polarizer is, for example, a polarizer yielded by causing a dichroic material such as iodine or dichroic dye to be adsorbed into a hydrophilic polymeric film, such as a polyvinyl alcohol-based film, a partially-formal-converted polyvinyl alcohol-based film or an ethylene/vinyl acetate copolymer partially-saponified film, and then stretching the resultant uniaxially; or a polyene-based aligned film made of, for example, a polyvinyl alcohol dehydrated-product or a polyvinyl chloride de-hydrochloride-treated-product. Out of such polarizers, preferred is a polarizer composed of a polyvinyl alcohol-based film and a dichroic substance such as iodine. The thickness of such a polarizer is not particularly limited, and is generally about 80 μm or less.

The polarizer in which a polyvinyl alcohol-based film dyed with iodine has been uniaxially stretched can be produced, for example, by immersing a polyvinyl alcohol into an aqueous solution of iodine to be dyed, and then stretching the resultant film into a length 3 to 7 times the original length of this film. As required, the stretched film may be immersed into an aqueous solution of, for example, boric acid or potassium iodide. Furthermore, before the dyeing, the polyvinyl alcohol-based film may be immersed into water as required to be cleaned with water. The cleaning of the polyvinyl alcohol-based film with water allows to clean stains and a blocking-preventing agent on surfaces of the polyvinyl alcohol-based film, and further produce an advantageous effect of swelling the polyvinyl alcohol-based film to prevent unevenness of the dyeing, and some other unevenness. The stretching may be performed after the dyeing with iodine or while the dyeing is performed. Alternatively, after the stretching, the dyeing with iodine may be performed. The stretching may be performed in an aqueous solution of, for example, boric acid or potassium iodide, or in a water bath.

When a thin polarizer having a thickness of 10 μm or less is used as the polarizer, the adhesive composition used in the present invention can remarkably produce the advantageous effect thereof (that the resultant adhesive layer satisfies optical endurance in a severe environment at a high temperature and high humidity). The polarizer, the thickens of which is 10 μm or less, is more largely affected by water than any polarizer having a thickness more than 10 μm, so that the former is insufficient in optical endurance in an environment at a high temperature and high humidity to be easily raised in transmittance or lowered in polarization degree. Accordingly, in the case of applying an activating treatment to an adhesive-layer-formation planned surface of the polarizer, the thickness of which is 10 μm or less, and the adhesive composition constituting the adhesive layer contains a shrinkage inhibitor, the problems of the invention of the present application can be especially effectively solved. The thickness of the polarizer is preferably from 1 to 7 μm from the viewpoint of making the polarizer thinner. Such a thin polarizer is small in thickness unevenness, excellent in viewability, and small in dimension change. Furthermore, this thin polarizer also favorably makes the thickness of the polarizing film small. The water content by percentage in the polarizer is preferably from 1 to 19% by weight. This case makes an especial improvement of the adhesive layer in adhering strength.

Typical examples of the thin polarizer include thin polarizing membranes described in JP-A-S51-069644, JP-A-2000-338329, a pamphlet of WO 2010/100917, and specifications of PCT/JP2010/001460 and Japanese Patent Applications No. 2010-269002 and No. 2010-263692. These thin polarizing membranes can each be yielded by a producing method including the step of stretching a polyvinyl alcohol-based resin (hereinafter referred to also as a PVA-based resin) and a resin substrate for stretching in a laminate state, and the step of dyeing the laminate. This producing method allows to stretch the laminate, even when the PVA-based resin layer is thin, without causing any inconvenience, such as breaking by the stretching, on the basis of the supporting of the PVA-based resin layer on the resin substrate for stretching.

The thin polarizing membranes are preferably polarizing membranes each yielded by the following producing method, out of producing methods including the step of stretching a PVA-based resin and a substrate in a laminate state and the step of dyeing the stretched laminate, since the laminate can be stretched into a large stretch ratio to improve the resultant polarizing membranes in polarizing performance: a producing method including the step of drawing the laminate in an aqueous solution of boric acid, as is described in a pamphlet of WO 2010/100917, and a specification of PCT/JP 2010/001460, or Japanese Patent Application No. 2010-269002 or 2010-263692. The membranes are in particular preferably membranes each yielded by a producing method including the step of stretching the laminate supplementally in the air before the stretching in the aqueous solution of boric acid, as is described in a specification of Japanese Patent Application No. 2010-269002 or 2010-263692.

### <Adhesive Composition>

The adhesive composition includes an active-energy-ray-curable component, and a shrinkage inhibitor having a structural formula having an M-O bond wherein M is silicon, titanium, aluminum or zirconium, and O represents an oxygen atom. It is particularly preferred in the invention that the shrinkage inhibitor is preferably at least one organometallic compound selected from the group consisting of organosilicon compounds, metal alkoxides, and metal chelates.

### <Organosilicon Compounds>

As any one of the organosilicon compounds, a compound having a Si—O bond is usable without any especial limitation. A specific example thereof is an active-energy-ray-curable organosilicon compound or an organosilicon compound having no active-energy-ray curability. The organic group which the organosilicon compound has in particular preferably has 3 or more carbon atoms. Examples of the active-energy-ray-curable compound include vinyltrichlorosilane, vinyltrimethoxysilane, vinyltriethoxysilane, 2-(3,4 epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

Preferred are 3-methacryloxypropyltrimethoxysilane, and 3-acryloxypropyltrimethoxysilane.

A specific example of the compound having no active-energy-ray curability is preferably a compound having an amino group. Specific examples of the compound having an amino group include γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilane, (2-aminoethyl)aminomethyltrimethoxysilane, N,N′-bis[3-(trimethoxysilyl)propyl]ethylenediamine, and other amino-group-containing silanes; and N-(1,3-dimethylbutylidene)-3-(triethoxysilyl)-1-propaneamine, and other ketimine type silanes.

Such compounds each having an amino group may be used singly or in any combination of two or more thereof. Out of the compounds, the following are preferred in order that the adhesive layer can ensure a good adhesion:
γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propanamine.

The blend amount of the organosilicon compound in the adhesive composition is preferably from 0.05 to 9 parts, preferably from 0.1 to 8 parts, more preferably from 0.15 to 5 parts by weight for 100 parts by weight of the total of the curable component (s). If the blend amount is more than 9 parts by weight, the adhesive composition is deteriorated in storage stability. If the amount is less than 0.05 parts by weight, the composition does not sufficiently produce adhesion water-resistance effect.

Specific examples of the compound having no active-energy-ray curability include, besides the above-mentioned examples, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazole silane.

<At Least One Organometallic Compound Selected from Group Consisting of Metal Alkoxides and Metal Chelates>

The metal alkoxides are each a compound in which at least one alkoxy group, which is an organic group, is bonded to a metal. The metal chelates are each a compound in which an organic group is bonded through an oxygen atom to a metal. The metals are each preferably titanium, aluminum or zirconium. Out of these metals, aluminum and zirconium are speedier in reactivity than titanium, and may make the pot life of the adhesive composition shorter and make the adhesion water-resistance improving effect smaller. Thus, the metal of the organometallic compounds is more preferably titanium from the viewpoint of an improvement of the adhesive layer in adhesion water-resistance.

When the adhesive composition used in the present invention includes, as an organometallic compound, a metal alkoxide, it is preferred to use a metal alkoxide having an organic group having 3 or more carbon atoms. The organic group more preferably contains 6 or more carbon atoms. If the number of the carbon atoms therein is 2 or less, the adhesive composition may become short in pot life and further the adhesion water-resistance improving effect may be lowered. The organic group having 6 or more carbon atoms is, for example, an octoxy group. This group is preferably usable. Preferred examples of the metal alkoxide include tetraisopropyl titanate, tetra-n-butyl titanate, a butyl titanate dimer, tetraoctyl titanate, t-amyl titanate, tetra-t-butyl titanate, tetrastearyl titanate, zirconium tetraisopropoxide, zirconium tetra-n-butoxide, zirconium tetraoctoxide, zirconium tetra-t-butoxide, zirconium tetrapropoxide, aluminum sec-butylate, aluminum ethylate, aluminum isopropylate, aluminum butylate, aluminum diisopropylate mono-sec-butyrate, and mono-sec-butoxyaluminum diisopropylate. Out of these examples, tetraoctyl titanate is preferred.

When the adhesive composition used in the present invention includes, as an organometallic compound, a metal chelate, it is preferred that the composition includes a metal chelate having an organic group having 3 or more carbon atoms. If the number of the carbon atoms therein is 2 or less, the adhesive composition may become short in pot life and further the adhesion water-resistance improving effect may be lowered. The organic group having 3 or more carbon atoms is, for example, an acetylacetonate, ethylacetoacetate, isostearate, or octyleneglycolate group. Out of these examples, the organic group is preferably an acetylacetonate or ethylacetoacetate group from the viewpoint of an improvement of the adhesive layer in adhesion water-resistance. Preferred examples of the metal chelate include titanium acetylacetonate, titanium octyleneglycolate, titanium tetraacetylacetonate, titanium ethylacetoacetate, polyhydroxytitanium stearate, dipropoxy-bis(acetylacetonato)titanium, dibutoxytitanium-bis(octyleneglycolate), dipropoxytitanium-bis(ethylacetoacetate), titanium lactate, titanium diethanolaminate, titanium triethanolaminate, dipropoxytitanium-bis(lactate), dipropoxytitanium-bis(triethanolaminate), di-n-butoxytitanium-bis(triethanolaminate), tri-n-butoxytitanium monostearate, diisopropoxy.bis(ethylacetoacetate) titanium, diisopropoxy.bis(acetylacetate) titanium, diisopropoxy.bis(acetylacetone) titanium, titanium phosphate compounds, a titanium lactate ammonium salt, titanium-1,3-propanedioxybis(ethylacetoacetate), a titanium dodecylbenzenesulfonate compound, titanium aminoethylaminoethanolate, zirconium tetraacetylacetonate, zirconium monoacetylacetonate, zirconium bisacetylacetonate, zirconium acetylacetonate bisethylacetoacetate, zirconium acetate, tri-n-butoxyethylacetoacetate zirconium, di-n-butoxybis(ethylacetoacetate) zirconium, n-butoxytris(ethylacetoacetate) zirconium, tetrakis(n-propylacetoacetate) zirconium, tetrakis(acetylacetoacetate) zirconium, tetrakis(ethylacetoacetate) zirconium, aluminum ethylacetoacetate, aluminum acetylacetonate, aluminum acetylacetonatebisethylacetoacetate, diisopropoxyethylacetoacetate aluminum, diisopropoxyacetylacetonate aluminum, isopropoxybis(ethylacetoacetate) aluminum, isopropoxybis(acetylacetonate) aluminum, tris(ethylacetoacetate) aluminum, tris(acetylacetonate) aluminum, and monoacetylacetonate bis(ethylacetoacetate) aluminum. Out of these examples, titanium acetylacetonate, and titanium ethylacetoacetate are preferred.

Examples of the organometallic compound usable in the present invention include, besides the above-mentioned compounds, zinc octoate, zinc laurate, zinc stearate, tin octoate, and other organic carboxylic acid metal salts; and acetylacetone zinc chelate, benzoylacetone zinc chelate, dibenzoylmethane zinc chelates, ethyl acetoacetate zinc chelate, and other zinc chelate compounds.

In the adhesive composition used in the present invention, the content proportion of the organometallic compound is preferably from 0.05 to 9 parts, preferably from 0.1 to 8 parts, more preferably from 0.1 to 8 parts, and further preferably from 0.15 to 5 parts by weight for 100 parts by weight of the total of the active-energy-ray-curable component(s). If the blend amount is more than 9 parts by weight, the adhesive composition may be deteriorated in storage stability, or the proportion of components that are to be bonded to the polarizer or the protective film becomes relatively short so that the adhesive composition may be lowered in adhesion. If the amount is less than 0.05 parts or less by weight, the adhesive composition does not sufficiently produce adhesion water-resistance effect.

From the viewpoint of an improvement of the organometallic compound in liquid stability in the composition, in the present invention, the composition may include a polymerizable compound having a polymerizable functional group and a carboxyl group together with the organometallic compound.

### <Polymerizable Compound Having Polymerizable Functional Group and Carboxyl Group>

The polymerizable compound having a polymerizable functional group and a carboxyl group has polymerizable and carboxyl groups. This compound may contain the one polymerizable functional group, or contain two or more polymerizable groups, and may contain the one carboxyl group, or contain two or more carboxyl groups.

The polymerizable functional group(s) is/are not particularly limited. Examples thereof include carbon-carbon-double-bond-containing groups, and epoxy, oxetanyl and vinyl ether groups.

The polymerizable functional group(s) is/are (each) in particular preferably a radical polymerizable functional group represented by the following general formula (I):

H₂C═C(R¹)—COO— (1)

wherein R¹ represents hydrogen or an organic group having 1 to 20 carbon atoms; or the following general formula (II):

H₂C═C(R²)—R³— (II)

wherein R¹ represents hydrogen or an organic group having 1 to 20 carbon atoms, and R³ represents a direct bond, or an organic group having 1 to 20 carbon atoms. Particularly preferred is a radical polymerizable functional group in which R¹ and R² are each hydrogen or a methyl group.

In the polymerizable compound having a polymerizable functional group and a carboxyl group, a position thereof to which the carboxyl group is bonded is not particularly limited. From the viewpoint of an improvement of the organometallic compound in the composition in liquid stability, a radical polymerizable compound in which a radical polymerizable functional group is bonded to a carboxyl group to interpose, therebetween, an organic group that has 1 to 20 carbon atoms and may contain oxygen is more preferred than (meth)acrylic acid, in which a radical polymerizable functional group is bonded directly to a carboxyl group.

From the viewpoint of an improvement of the organometallic compound in the composition in liquid stability, it is preferred that: the molecular weight of the polymerizable compound having a polymerizable functional group and a carboxyl group is large; when this polymerizable compound is bonded and/or coordinated to the organometallic compound, the polymerizable compound is bulky; and when a different ligand is coordinated thereto, the polymerizable compound gives a steric hindrance. Thus, the molecular weight of the polymerizable compound having a polymerizable functional group and a carboxyl group is 100 g/mol or more, more preferably 125 g/mol or more, in particular preferably 150 g/mol or more. The upper limit of the polymerizable compound having a polymerizable functional group and a carboxyl group is not particularly limited, and is, for example, about 300 g/mol.

From the viewpoint of an improvement of the organometallic compound in the composition in liquid stability, the polymerizable compound having a polymerizable functional group and a carboxyl group is preferably a polymerizable compound having a polymerizable functional group and a carboxyl group to interpose, therebetween, an organic group that has 1 to 20 carbon atoms and may contain oxygen. Examples of such an organic group include alkyl, alkenyl, alkynyl, alkylidene, alicyclic, unsaturated alicyclic, alkyl ester, aromatic ester, acyl, hydroxyalkyl, and alkylene oxide groups. About such organic groups, a single group thereof may be present, or the same plural organic groups may be bonded to each other or different organic groups may be bonded to each other. Specific examples of the polymerizable compound (B) include β-carboxyethyl acrylate, carboxypentyl acrylate, β-carboxyethyl methacrylate, 2-acryloyloxyethyl-succinic acid, 2-acryloyloxyethylhexahydrophthalic acid, 2-acryloyloxyethyl phthalic acid, w̅-carboxy-polycaprolactone monoacrylate, 2-acryloyloxyethyltetrahydrophthalic acid, 2-acryloyloxypropyloxy phthalic acid, 2-acryloyloxypropyltetrahydrophthalic acid, 2-acryloyloxypropylhexahydrophthalic acid, methacryloyloxyethylsuccinic acid, methacryloyloxyethylphthalic acid, methacryloyloxyethyltetrahydrophthalic acid, methacryloyloxyethylhexahydrophthalic acid, 2-methacryloyloxypropyloxyphthalic acid, 2-methacryloxypropyltetrahydrophthalic acid, and 2-methacryloxypropylhexahydrophthalic acid.

When the total amount of the organometallic compound in the adhesive composition is regarded as a (mol), the content of the polymerizable compound having a polymerizable functional group and a carboxyl group is preferably 0.25a (mol) or more, more preferably 0.35a (mol) or more, in particular preferably 0.5a (mol) or more from the viewpoint of an improvement of the organometallic compound in the composition in liquid stability. If the content of the polymerizable compound having a polymerizable functional group and a carboxyl group is less than 0.25α (mol), the stabilization of the organometallic compound becomes insufficient so that hydrolysis reaction and self-condensation reaction thereof advance. Consequently, the pot life of the resultant polarizing film may be shortened. The upper limit of the content of the polymerizable compound having a polymerizable functional group and a carboxyl group in the total amount α (mol) is not particularly limited, and may be, for example, about 4α (mol).

The adhesive composition used in the present invention preferably contains a compound represented by the following general formula (I):

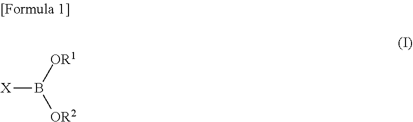

wherein X is a functional group containing a reactive group, and R¹ and R² each independently represent a hydrogen atom, or an aliphatic hydrocarbon, aryl or heterocyclic group that may have a substituent. The aliphatic hydrocarbon group is, for example, a linear or branched alkyl group which has 1 to 20 carbon atoms and may have a substituent, a cyclic alkyl group which has 3 to 20 carbon atoms and may have a substituent, or an alkenyl group which has 2 to 20 carbon atoms. The aryl group is, for example, a phenyl group which has 6 to 20 carbon atoms and may have a substituent, or a naphthyl group which has 10 to 20 carbon atoms and may have a substituent. The heterocyclic group is, for example, a 5-membered or 6-membered group which contains at least one heteroatom, and may have a substituent. These may be linked to each other to form a ring. In the general formula (I), R¹ and R² are each preferably a hydrogen atom, or a linear or branched alkyl group having 1 to 3 carbon atoms, and are each more preferably a hydrogen atom.

The functional group X, which the compound represented by the general formula (I) has, is a functional group containing a reactive group, and is a functional group that can reactive with a different curable component included in the curable resin composition. Examples of the reactive group, which X contains, include hydroxyl, amino, aldehyde, carboxyl, vinyl, (meth)acryl, styryl, (meth)acrylamide, vinyl ether, epoxy, oxetane groups. When the curable resin composition used in the present invention is active-energy-ray curable, the reactive group, which X contains, is preferably at least one reactive group selected from the group consisting of vinyl, (meth)acryl, styryl, (meth)acrylamide, vinyl ether, epoxy, oxetane and mercapto groups. When the curable resin composition is, particularly, radical polymerizable, the reactive group, which X contains, is at least one reactive group selected from the group consisting of (meth)acryl, styryl, and (meth)acrylamide groups. More preferably, the compound represented by the general formula (I) has a (meth)acrylamide group since the compound is high in reactivity to be increased in copolymerization rate in the active-energy-ray-curable resin composition. Moreover, this case is preferred also since the (meth)acrylamide group is high in polarity so that the resultant adhesive is excellent in adhesion. Consequently, the advantageous effects of the present invention can be effectively gained. When the curable resin layer used in the present invention is cationic polymerizable, the reactive group, which X contains, preferably has at least one functional group selected from the group consisting of hydroxyl, amino, aldehyde, carboxyl, vinyl ether, epoxy, oxetane, and mercapto groups. When the reactive group has, particularly, an epoxy group, close adhesion between the resultant curable resin layer and an adherend is favorably excellent. When the reactive group has a vinyl ether group, the curable resin composition is favorably excellent in curability.

A preferred and specific example of the compound represented by the general formula (I) is a compound represented by the following general formula (I′):

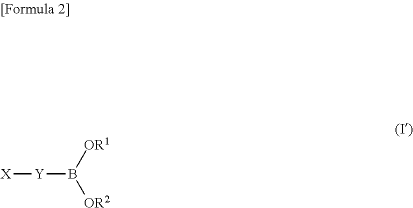

wherein Y is an organic group, and X, R¹ and R² are the same as described above. More preferred examples thereof include the following compounds (1a) to (1d):

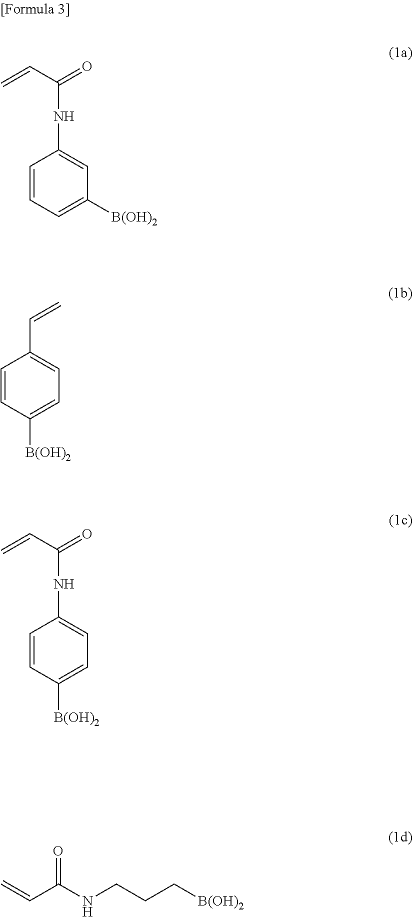

In the present invention, the compound represented by the general formula (I) may be a compound in which a reactive group is bonded directly to a boron atom. However, as illustrated as the above-mentioned specific examples, it is preferred that the compound represented by the general formula (I) is a compound in which a reactive group and a boron atom are bonded to each other to interpose, therebetween, an organic group, that is, a compound represented by the general formula (I′). When the compound represented by the general formula (I) is, for example, a compound in which a boron atom is bonded to a reactive group to interpose, therebetween, an oxygen atom bonded to the boron atom, an adhesive layer yielded by curing the curable resin composition containing this compound tends to be deteriorated in adhesion water-resistance. In the meantime, in a case where the compound represented by the general formula (I) is not a compound having a boron-oxygen atom, but a compound in which a boron atom is bonded to an organic group so that while this compound has a boron-carbon bond, the compound contains a reactive group (in the case of the general formula (I′)), the adhesive layer is favorably improved in adhesion water-resistance. The organic group specifically denotes an organic group that has 1 to 20 carbon atoms and may have a substituent. More specific examples thereof include any linear or branched alkylene group that has 1 to 20 carbon atoms and may have a substituent, any cyclic alkylene group that has 3 to 20 carbon atoms and may have a substituent, any phenylene group that has 6 to 20 carbon atoms and may have a substituent, and any naphthylene group that has 10 to 20 carbon atoms and may have a substituent.

Examples of the compound represented by the general formula (I) include, besides the compounds given above as the examples thereof, an ester made from hydroxyethylacrylamide and boric acid, an ester made from methylolacrylamide and boric acid, an ester made from hydroxyethyl acrylate and boric acid, an ester made from hydroxybutyl acrylate and boric acid, and any other ester made from a (meth)acrylate and boric acid.

The content of the compound illustrated as the general formula (1) in the curable resin composition is preferably from 0.001 to 50%, more preferably from 0.1 to 30%, most preferably from 1 to 10% by weight of the composition to improve the adhesion between the polarizer and the curable resin layer and the water resistance thereof, in particular, to improve the adhesion and the water resistance when the polarizer and the transparent protective film are bonded to each other through the adhesive layer.

### <Curable Component>

The adhesive composition used in the present invention includes, as a curable component, an active-energy-ray-curable component.

As the curable component, a component in an active-energy-ray-curable adhesive form is preferably usable, examples of this form including an electron beam curable form, an ultraviolet curable form, and a visible ray curable from. Furthermore, adhesive compositions in the ultraviolet curable form and the visible ray curable form can be roughly classified into radical polymerization curable adhesive compositions, and cationic polymerization adhesive compositions. In the present invention, any active energy ray having a wavelength in a range of 10 to 380 nm is described as an ultraviolet ray; and any active energy ray having a wavelength in a range from 380 to 800 nm, as a visible ray.

### <1: Radical Polymerization Curable Resin Composition>

The curable component is, for example, a radical polymerizable compound used in any radical polymerization curable resin composition. The radical polymerizable compound is, for example, a compound having a radical polymerizable functional group of a carbon-carbon double bond, such as a methacryloyl group or a vinyl group. Such a curable component may be either a monofunctional radical polymerizable compound, or a bifunctional or higher polyfunctional radical polymerizable compound. Such radical polymerizable compounds may be used singly, or in any combination of two or more thereof. The radical polymerizable compound(s) is/are (each), for example, a compound having a (meth)acryloyl group. In the present invention, the word “(meth)acryloyl” denotes an acryloyl group and/or a methacryloyl group. The notation “(meth)a” has substantially the same meanings hereinafter.

### <<Monofunctional Radical Polymerizable Compound>>

The monofunctional radical polymerizable compound is, for example, a (meth)acrylamide derivative having a (meth)acrylamide group. The (meth)acrylamide derivative is preferred for the purpose of ensuring the adhesion of the curable component to the polarizer and the transparent protective film that may be of various types, and because of a large polymerization rate of the derivative, which gives an excellent producing performance. Specific examples of the (meth)acrylamide derivative include N-methyl(meth)acrylamide, N,N-dimethyl(meth)acrylamide, N,N-diethyl(meth)acrylamide, N-isopropyl(meth)acrylamide, N-butyl(meth)acrylamide, N-hexyl(meth)acrylamide, and other N-alkyl-group-containing (meth)acrylamide derivatives; N-methylol(meth)acrylamide, N-hydroxyethyl(meth)acrylamide, N-methylol-N-propane(meth)acrylamide, and other N-hydroxyalkyl-group-containing (meth)acrylamide derivatives; aminomethyl(meth)acrylamide, aminoethyl(meth)acrylamide, and other N-aminoalkyl-group-containing (meth)acrylamide derivatives; N-methoxymethylacrylamide, N-ethoxymethylacrylamide, and other N-alkoxy-group-containing (meth)acrylamide derivatives; and mercaptomethyl(meth)acrylamide, mercaptoethyl(meth)acrylamide, and other N-mercaptoalkyl-group-containing (meth)acrylamide derivatives. Examples of the heterocycle-containing (meth)acrylamide derivative, in which a nitrogen atom of a (math)acrylamide group forms a heterocycle, include N-acryloylmorpholine, N-acryloylpiperidine, N-methacryloylpiperidine, and N-acryloylpyrrolidine.

Out of the above-mentioned (meth)acrylamide derivatives, any N-hydroxyalkyl-group-containing (meth)acrylamide derivative is preferred, and N-hydroxyethyl(meth)acrylamide is particularly preferred from the viewpoint of the adhesion of the adhesive composition to the polarizer and the transparent protective film that may be of various types.

Other examples of the monofunctional radical polymerizable compound include various (meth)acrylic acid derivatives each having a (meth)acryloyloxy group. Specific examples thereof include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, s-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, n-octadecyl (meth)acrylate, and other (C₁ to C₂₀) alkyl (meth)acrylates.

Examples of the above-mentioned (meth)acrylic acid derivatives include cyclohexyl (meth)acrylate, cyclopentyl (meth)acrylate, and other cycloalkyl (meth)acrylates; benzyl (meth)acrylate, and other aralkyl (meth)acrylates; 2-isobornyl (meth)acrylate, 2-norbornylmethyl (meth)acrylate, 5-norbornene-2-yl-methyl (meth)acrylate, 3-methyl-2-norbornylmethyl (meth)acrylate, dicyclopentenyl (meth)acrylate, dicyclopentenyloxyethyl (meth)acrylate, dicyclopentanyl (meth)acrylate, and other polycyclic (meth)acrylates; and 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, phenoxyethyl (meth)acrylate, alkylphenoxy polyethylene glycol (meth)acrylate, and other alkoxy-group or phenoxy-group-containing (meth)acrylates.

Examples of the above-mentioned (meth)acrylic derivatives include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and other hydroxyalkyl (meth)acrylates; [4-(hydroxymethyl)cyclohexyl]methyl acrylate, cyclohexanedimethanol mono(meth)acrylate, 2-hydroxy-3-phenoxypropyl (meth)acrylate, and other hydroxyl-group-containing (meth)acrylates; glycidyl (meth)acrylate, 4-hydroxybutyl (meth)acrylate glycidyl ether, and other epoxy-group-containing (meth)acrylates; 2,2,2-trifluoroethyl (meth)acrylate, 2,2,2-trifluoroethyl (meth)acrylate, tetrafluoropropyl (meth)acrylate, hexafluoropropyl (meth)acrylate, octafluoropentyl (meth)acrylate, heptadecafluorodecyl (meth)acrylate, 3-chloro-2-hydroxypropyl (meth)acrylate, and other halogen-containing (meth)acrylates; dimethylaminoethyl (meth)acrylate, and other alkylaminoalkyl (meth)acrylates; 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, 3-hexyl-oxetanylmethyl (meth)acrylate, and other oxetane-group-containing (meth)acrylates; tetrahydrofurfuryl (meth)acrylate, butyrolactone (meth)acrylate, and other heterocycle-having (meth)acrylates; and a (meth)acrylic acid adduct of neopentylglycol hydroxypivalate, and p-phenylphenol (meth)acrylate.

Examples of the monofunctional radical polymerizable compound include (meth)acrylic acid, carboxyethyl acrylate, carboxypentyl acrylate, itaconic acid, maleic acid, fumaric acid, crotonic acid, isocrotonic acid, β-carboxyethyl acrylate, carboxypentyl acrylate, β-carboxyethyl methacrylate, 2-acryloyloxyethyl-succinic acid, 2-acryloyloxyethylhexahydrophthalic acid, 2-acryloyloxyethylphthalic acid, ω-carboxy-polycaprolactone monoacrylate, 2-acryloyloxyethyltetrahydrophthalic acid, 2-acryloyloxypropyloxy phthalic acid, 2-acryloyloxypropyltetrahydrophthalic acid, 2-acryloyloxypropylhexahydrophthalic acid, methacryloyloxyethylsuccinic acid, methacryloyloxyethylphthalic acid, methacryloyloxyethyl tetrahydrophthalic acid, methacryloyloxyethylhexahydrophthalic acid, 2-methacryloyloxypropyloxyphthalic acid, 2-methacryloyloxypropyltetrahydrophthalic acid, 2-methacryloyloxypropylhexahydrophthalic acid, and other carboxyl-group-containing monomers.

Other examples of the monofunctional radical polymerizable compound include N-vinylpyrrolidone, N-vinyl-ε-caprolactam, methylvinylpyrrolidone, and other lactam-based vinyl monomers; and vinylpyridine, vinylpiperidone, vinylpyrimidine, vinylpiperazine, vinylpyrazine, vinylpyrrole, vinylimidazole, vinyloxazole, vinylmorpholine, and other vinyl-based monomers each having a nitrogen-containing heterocycle.

The monofunctional radical polymerizable compound may also be a radical polymerizable compound having an active methylene group. The radical polymerizable compound having an active methylene group is a compound having, at a terminal thereof or in the molecule thereof, an active double bond group such as a (meth)acryl group, and further having an active methylene group. Examples of the active methylene group include acetoacetyl, alkoxymalonyl, and cyanoacetyl groups. The active methylene group is preferably an acetoacetyl group. Specific examples of the radical polymerizable compound having an active methylene group include 2-acetoacetoxyethyl (meth)acrylate, 2-acetoacetoxypropyl (meth)acrylate, 2-acetoacetoxy-1-methylethyl (meth)acrylate, and other acetoacetoxyalkyl (meth)acrylates; and 2-ethoxymalonyloxyethyl (meth)acrylate, 2-cyanoacetoxyethyl (meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radical polymerizable compound having an active methylene group is preferably an acetoacetoxyalkyl (meth)acrylate.

### <<Polyfunctional Radical Polymerizable Compound>>

Examples of the bi- or higher polyfunctional radical polymerizable compound include N,N′-methylenebis(meth)acrylamide, which is a polyfunctional (meth)acrylamide derivative, tripropylene glycol di(meth)acrylate, tetraethylene glycol di(meth)acrylate, 1,6-hexanediol di(meth)acrylate, 1,9-nonanediol di(meth)acrylate, 1,10-decanediol diacrylate, 2-ethyl-2-butylpropanediol di(meth)acrylate, bisphenol A di(meth)acrylate, bisphenol A ethylene oxide adduct di(meth)acrylate, bisphenol A propylene oxide adduct di(meth)acrylate, bisphenol A diglycidyl ether di(meth)acrylate, neopentyl glycol di(meth)acrylate, tricyclodecanedimethanol di(meth)acrylate, cyclic trimethylolpropaneformal (meth)acrylate, dioxane glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, EO-modified diglycerin tetra(meth)acrylate, and other esterified products each made from (meth)acrylic acid and a polyhydric alcohol, and 9,9-bis[4-(2-(meth)acryloyloxyethoxy)phenyl]fluorene. Preferred and specific examples thereof include ARONIX M-220 (manufactured by Toagosei Co., Ltd.), LIGHT ACRYLATE 1,9 ND-A (manufactured by Kyoeisha Chemical Co., Ltd.), LIGHT ACRYLATE DGE-4A (manufactured by Kyoeisha Chemical Co., Ltd.), LIGHT ACRYLATE DCP-A (manufactured by Kyoeisha Chemical Company, Ltd.), SR-531 (manufactured by a company Sartomer Co.), and CD-536 (manufactured by the company Sartomer). As the need arises, for example, the following are used: various epoxy (meth)acrylates, urethane (meth)acrylates, polyester (meth)acrylates, and various (meth)acrylate monomers. The polyfunctional (meth)acrylamide derivative is preferably incorporated into the curable resin composition since the derivative gives a large polymerization rate to give an excellent producing performance, and further at the time of making the resin composition into a cured product the derivative gives an excellent crosslinking performance.

As such radical polymerizable compounds, the monofunctional radical polymerizable compound and the polyfunctional radical polymerizable compound are preferably used together with each other in order to make the following compatible with each other: the adhesion of the resultant layer to the polarizer and the transparent protective film that may be of various types; and the optical endurance of the resultant polarizing film in a severe environment. It is usually preferred to use the monofunctional radical polymerizable compound in a proportion of 3 to 80% by weight of the radical polymerizable compounds, the proportion thereof being 100% by weight, and the polyfunctional radical polymerizable compound in a proportion of 20 to 97% by weight thereof.

### <Embodiments of Radical Polymerization Curable Adhesive Composition>

The adhesive composition used in the present invention is usable as an active-energy-ray-curable adhesive composition when the curable component of this composition is used as an active-energy-ray-curable component. When an electron beam or the like is used as the active energy ray, the active-energy-ray-curable resin composition does not need to contain any photopolymerization initiator. When an ultraviolet ray or visible ray is used as the active energy ray, this composition preferably contains a photopolymerization initiator.

### <<Photopolymerization Initiator>>

When the radical polymerizable compound is used, the photopolymerization initiator is appropriately selected in accordance with the active energy ray. When the compound is cured by an ultraviolet ray or visible ray, an ultraviolet or visible-ray-cleavable photopolymerization initiator is used. Examples of this photopolymerization initiator include benzil, benzophenone, benzoylbenzoic acid, 3,3′-dimethyl-4-methoxybenzophenone, and other benzophenone-based compounds; 4-(2-hydroxyethoxy)phenyl (2-hydroxy-2-propyl) ketone, α-hydroxy-α,α′-dimethylacetophenone, 2-methyl-2-hydroxypropiophenone, α-hydroxycyclohexyl phenyl ketone, and other aromatic ketone compounds; methoxyacetophenone, 2,2-dimethoxy-2-phenylacetophenone, 2,2-diethoxyacetophenone, 2-methyl-1-[4-(methylthio)-phenyl]-2-morpholinopropane-1, and other acetophenone-based compounds; benzoin methyl ether, benzoin ethyl ether, benzoin isopropyl ether, benzoin butyl ether, anisoin methyl ether, and other benzoin ether-based compounds; benzyl dimethyl ketal, and other aromatic ketal compounds; 2-naphthalenesulfonyl chloride, and other aromatic sulfonyl chloride-based compounds; 1-phenone-1,1-propanedione-2-(o-ethoxycarbonyl)oxime, and other optically active oxime compounds; thioxanthone, 2-chlorothioxanthone, 2-methyithioxanthone, 2,4-dimethylthioxanthone, isopropylthioxanthone, 2,4-dichlorothioxanthone, 2,4-diethylthioxanthone, 2,4-diisopropylthioxanthone, dodecylthioxanthone, and other thioxanthone-based compounds; camphorquinone; halogenated ketones; and acylphosphonoxide; and acylphosphonate.

The blend amount of the photopolymerization initiator is 20 parts or less by weight for 100 parts by weight of the whole of the curable components (radical polymerizable compounds). The blend amount of the photopolymerization initiator is preferably from 0.01 to 20 parts, more preferably from 0.05 to 10 parts, even more preferably from 0.1 to 5 parts by weight therefor.

When the adhesive composition used in the present invention is used in a visible ray curable form which includes, as a curable component thereof, a radical polymerizable compound, it is preferred to use a photopolymerization initiator high in sensitivity, particularly, to light rays having a wavelength of 380 nm or more. About the photopolymerization initiator high in sensitivity to light rays having a wavelength of 380 nm or more, a description will be made later.

It is preferred to use, as the photopolymerization initiator or such photopolymerization initiators, a compound represented by the following general formula (1) singly:

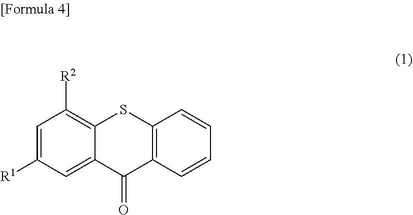

wherein R¹ and R² each represent —H, —CH₂CH₃, -iPr or Cl, and R¹ and R² may be the same as or different from each other; or use the compound represented by the general formula (1) together with a photopolymerization initiator high in sensitivity to light rays having a wavelength of 380 nm or more, which will be detailed later. When the compound represented by the general formula (1) is used, the cured product is better in adhesion than when the photopolymerization initiator high in sensitivity to light rays having a wavelength of 380 nm or more is used singly. Out of compounds each represented by the general formula (1), diethylthioxanthone, in which R¹ and R² are each —CH₂CH₃, is particularly preferred. The composition proportion of the compound represented by the general formula (1) in the adhesive composition is preferably from 0.1 to 5 parts, more preferably from 0.5 to 4 parts, even more preferably from 0.9 to 3 parts by weight for 100 parts by weight of the whole of the adhesive components.

As required, a polymerization initiation aid is preferably added into the composition. Examples of the polymerization initiation aid include triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate. Ethyl 4-dimethylaminobenzoate is particularly preferred. When the polymerization initiation aid is used, the addition amount thereof is usually from 0 to 5 parts, preferably from 0 to 4 parts, most preferably from 0 to 3 parts by weight for 100 parts by weight of the whole of the curable components.

As required, a known photopolymerization initiator may be together used. A transparent protective film having a UV absorbing power does not transmit any light ray of 380 nm or less wavelengths. Thus, it is preferred to use, as the photopolymerization initiator, a photopolymerization initiator high in sensitivity to light rays of 380 nm or more wavelength. Specific examples thereof include 2-methyl-1-(4-methylthiophenyl)-2-morpholinopropane-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, bis(η5-2,4-cyclopentadiene-1-yl)-bis(2,6-difluoro-3-(1H-pyrrol-1-yl)-phenyl)titanium.

It is particularly preferred that in addition to the photopolymerization initiator of the general formula (1), a compound represented by the following general formula (2) is used as a photopolymerization initiator:

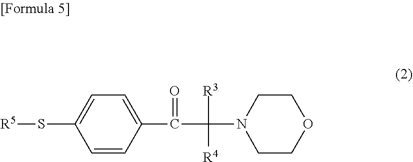

wherein, R³, R⁴ and R⁵ each represent —H, —CH₃, —CH₂CH₃, -iPr or Cl, and R³, R⁴ and R⁵ may be the same or different. A preferably usable example of the compound represented by the general formula (2) is 2-methyl-1-(4-methylthiophenyl)-2-morpholinopropane-1-one, which is also a commercially available product (trade name: IRGACURE 907, manufacturer: the company BASF). Additionally, the following are preferred because of high sensitivity thereof:
2-benzyl-2-dimethylamino-1-(4-morpholinophenyl)-butanone-1 (trade name: IRGACURE 369, manufacturer: the company BASF), 2-(dimethylamino)-2-[(4-methylphenyl)methyl]-1-[4-(4-morpholinyl)phenyl]-1-butanone (trade name: IRGACURE 379, manufacturer: the company BASF).

### <Radical Polymerizable Compound Having Active Methylene Group, and Radical Polymerization Initiator Having Hydrogen-Withdrawing Effect>

In the case of using, as the radical polymerizable compound, a radical polymerizable compound having an active methylene group in the active-energy-ray-curable adhesive composition, it is preferred to use a combination of this compound with a radical polymerization initiator having hydrogen-withdrawing effect. This structure makes a remarkable improvement of the adhesive layer, which the pressure-sensitive-adhesive layer attached polarizing film has, in adhesion even immediately after the polarizing film is taken out, particularly, from a high-humidity environment or water (even when the film is in a non-dry state). Reasons therefor are unclear. However, the improvement would be based on the following causes: While the radical polymerizable compound having an active methylene group is polymerized together with the other radical polymerizable compounds that will be included in the adhesive layer, the compound is taken into a main chain and/or side chains of a base polymer in the adhesive layer to form the adhesive layer. In this polymerizing step, in the presence of the radical polymerization initiator having hydrogen-withdrawing effect, the base polymer, which will be included in the adhesive layer, is formed and simultaneously hydrogen is withdrawn from the active-methylene-having radical polymerizable compound to generate radicals in methylene groups of molecules of the compound. The methylene groups in which radicals are generated react with hydroxyl groups of the polarizer, such as ones of PVA, so that covalent bonds are formed between the adhesive layer and the polarizer. Consequently, the adhesive layer which the pressure-sensitive-adhesive layer attached polarizing film has would be remarkably improved in adhesion even when the polarizing film is, particularly, in a non-dry state.

In the present invention, the radical polymerization initiator having hydrogen-withdrawing effect is, for example, a thioxanthone-based radical polymerization initiator, or a benzophenone-based radical polymerization initiator. The radical polymerization initiator is preferably a thioxanthone-based radical polymerization initiator. The thioxanthone-based radical polymerization initiator is, for example, a compound represented by the general formula (1). Specific examples of the compound represented by the general formula (1) include thioxanthone, dimethylthioxanthone, diethylthioxanthone, isopropylthioxanthone, and chlorothioxanthone. Out of compounds represented by the general formula (1), particularly preferred is diethylthioxanthone, in which R¹ and R² are each —CH₂CH₃.

When the active-energy-ray-curable adhesive composition contains the radical polymerizable compound having an active methylene group and the radical polymerization initiator having hydrogen-withdrawing effect, it is preferred that the radical polymerizable compound having an active methylene group is contained in a proportion of 1 to 50% by weight of the whole of the curable components, the proportion thereof being 100% by weight, and the radical polymerization initiator is contained in a proportion of 0.1 to 10 parts by weight for 100 parts by weight of the whole of the curable components.

As described above, in the present invention, radicals are generated in methylene groups of molecules of the active-methylene-group-having radical polymerizable compound in the presence of the radical polymerization initiator having hydrogen-withdrawing effect. The methylene groups react with hydroxyl groups of the polarizer, such as ones of PVA, to form covalent bonds. Thus, in order to generate radicals in the methylene groups of the molecules of the active-methylene-group-having radical polymerizable compound to form covalent bonds sufficiently, the active-methylene-group-having radical polymerizable compound is incorporated into the composition preferably in a proportion of 1 to 50%, more preferably in a proportion of 3 to 30% by weight of the whole of the curable components, the proportion thereof being 100% by weight. In order to improve the adhesive layer in water resistance sufficiently to improve this layer in adhesion in a non-dry state, the proportion of the active-methylene-group-having radical polymerizable compound is set preferably to 1% or more by weight. In the meantime, if the proportion is more than 50% by weight, the adhesive layer may be poorly cured. The radical polymerization initiator having hydrogen-withdrawing effect is contained preferably in a proportion of 0.1 to 10 parts, more preferably in a proportion of 0.3 to 9 parts by weight for 100 parts by weight of the whole of the curable components. In order to cause the hydrogen-withdrawing reaction sufficiently, the radical polymerization initiator is used in an amount of 0.1 parts or more by weight. In the meantime, if the amount is more than 10 parts by weight, the initiator may not be completely dissolved in the composition.

### <2: Cation Polymerization Curable Adhesive Composition>

The cation polymerizable compound used in the cation polymerization curable resin composition is classified into a monofunctional cation polymerizable compound, which has in the molecule thereof a single cation polymerizable functional group, or a polyfunctional cation polymerizable compound, which has in the molecule thereof two or more cation polymerizable functional groups. The monofunctional cation polymerizable compound is relatively low in liquid viscosity; thus, when this compound is incorporated into the resin composition, the resin composition can be lowered in liquid viscosity. Moreover, in many cases, the monofunctional cation polymerizable compound has a functional group for expressing various functions. Thus, the incorporation of this compound into the resin composition can cause various functions to be expressed in the resin composition and/or a cured product of the resin composition. The polyfunctional cation polymerizable compound allows to crosslink the cured product of the resin composition three-dimensionally. Thus, this compound is preferably incorporated into the resin composition. About the ratio between the monofunctional cation polymerizable compound and the polyfunctional cation polymerizable compound, the latter is preferably blended into the former in an amount of 10 to 1000 parts by weight for 100 parts by weight of the former. The cation polymerizable functional group may be an epoxy, oxetanyl or vinyl ether group. Examples of a compound having this epoxy group include aliphatic epoxy compounds, alicyclic epoxy compounds, and aromatic epoxy compounds. The cation polymerization curable resin composition in the present invention in particular preferably contains an alicyclic epoxy compound since the composition is excellent in curability and adhesion. Examples of the alicyclic epoxy compound include 3,4-epoxycyclohexylmethyl-3,4-epoxycyclohexane carboxylate, and caprolactone-modified products, trimethyl caprolactone modified products or valerolactone-modified products of 3,4-epoxycyclohexylmethyl-3,4-epoxycyclohexane carboxylate. Specific examples thereof include products CELLOXIDE 2021, CELLOXIDE 2021A, CELLOXIDE 2021P, CELLOXIDE 2081, CELLOXIDE 2083, and CELLOXIDE 2085 (each manufactured by Daicel Corp); and CYRACURE UVR-6105, CYRACURE UVR-6107, CYRACURE 30, and R-6110 (manufactured by Dow Chemical Japan Ltd.). It is preferred to incorporate a compound having the above-mentioned oxetanyl group into the cation polymerizable curable resin composition of the present invention since the compound has advantageous effects of improving the composition in curability and lower the composition in liquid viscosity. Examples of the oxetanyl-group-having compound include 3-ethyl-3-hydroxymethyloxetane, 1,4-bis[(3-ethyl-3-oxetanyl)methoxymethyl]benzene, 3-ethyl-3-(phenoxymethyl)oxetane, di[(3-ethyl-3-oxetanyl)methyl] ether, 3-ethyl-3-(2-ethylhexyloxymethyl) oxetane, and phenol novolac oxetane. The following are commercially available: products ARON OXETANE OXT-101, ARON OXETANE OXT-121, ARON OXETANE OXT-211, ARON OXETANE OXT-221, and ARON OXETANE OXT-212 (each manufactured by Toagosei Co., Ltd.). A compound having the above-mentioned vinyl ether group has an effect of improving the cation polymerization curable resin composition in curability or lowering the composition in liquid viscosity; thus, this compound is preferably incorporated into the composition. Examples of the vinyl-ether-group-having compound include 2-hydroxyethyl vinyl ether, diethylene glycol monovinyl ether, 4-hydroxybutyl vinyl ether, diethylene glycol monovinyl ether, triethylene glycol divinyl ether, cyclohexanedimethanol divinyl ether, cyclohexanedimethanol monovinyl ether, tricyclodecane vinyl ether, cyclohexyl vinyl ether, methoxyethyl vinyl ether, ethoxyethyl vinyl ether, and pentaerythritol type tetravinyl ether.

### <Cation Photopolymerization Initiator>

The cation polymerization curable resin composition includes, as a curable component, at least one compound selected from the above-mentioned epoxy-group-having compound, the oxetanyl-group-having compound and the vinyl-ether-group-having compound, and these compounds are each cured by cation polymerization. Thus, a cation photopolymerization initiator is blended into the composition. This cation photopolymerization initiator is irradiated with an active energy ray such as a visible ray, an ultraviolet ray, an X ray or an electron beam to generate a cationic species or Lewis acid to initiate the polymerization reaction of epoxy groups and oxetanyl groups. The cation photopolymerization initiator is preferably an optical acid generator which will be detailed later. When the curable resin composition used in the present invention is used in a visible ray curable form, it is preferred to use a cation photopolymerization initiator high in sensitivity to light rays having wavelengths of 380 nm or more. In general, cation photopolymerization initiators are each a compound showing a maximum absorption near 300 nm or in the range of wavelengths shorter than 300 nm. Thus, by blending, into the composition, a photosensitizer showing a maximum absorption in the range of wavelengths longer than 300 nm, specifically, at light wavelengths longer than 380 nm, the photosensitizer sensitizes light rays each having a wavelength near this wavelength so that the generation of a cation species or acid can be promoted from the cation photopolymerization initiator. Examples of the photosensitizer include anthracene compounds, pyrene compounds, carbonyl compounds, organic sulfur compounds, persulfates, redox compounds, azo and diazo compounds, halogenated compounds, and optically reducible colorants. These photosensitizers may be used in the form of a mixture of two or more thereof. In particular, anthracene compounds are preferred because of an excellent photosensitizing effect thereof. Specific examples thereof include products ANTHRACURE UVS-1331, and ANTHRACURE UVS-1221 (manufactured by Kawasaki Kasei Chemicals Co., Ltd.). The content of the photosensitizer(s) is preferably from 0.1 to 5% by weight, more preferably from 0.5 to 3% by weight.

### <Other Components>

The curable resin composition used in the present invention preferably contains the following components.

### <Acrylic Oligomer>

The adhesive composition used in the present invention may contain, besides the curable components related to the above-mentioned radical polymerizable compound, an acrylic oligomer obtained by polymerizing a (meth)acrylic monomer. By incorporating the component into the active-energy-ray-curable adhesive composition, this composition is decreased in cure shrinkage when irradiated with an active energy ray to be cured, so that interfacial stress can be decreased between the adhesive, and adherends such as a polarizer and a transparent protective film. As a result, the adhesion between the adhesive layer and the adherends can be restrained from being lowered. In order to restrain the cure shrinkage of the cured product layer (adhesive layer) sufficiently, the content of the acrylic oligomer is preferably 20 parts or less, more preferably 15 parts or less by weight for 100 parts by weight of the whole of the curable components. If the content of the acrylic oligomer in the adhesive composition is too large, the composition is intensely lowered in reaction rate when irradiated with an active energy ray. Thus, the composition may be poorly cured. In the meantime, the acrylic oligomer is contained in an amount that is preferably 3 parts or more, more preferably 5 parts or more by weight for 100 parts by weight of the whole of the curable components.

The active-energy-ray-curable adhesive composition is preferably low in viscosity in a case where a consideration is made about the workability or evenness of the composition when the composition is applied. Thus, it is also preferred that the acrylic oligomer (A), which is obtained by polymerizing a (meth)acrylic monomer, is also low in viscosity. About the acrylic oligomer that is low in viscosity and can prevent the resultant adhesive layer from undergoing cure shrinkage, the weight-average molecular weight (Mw) thereof is preferably 15000 or less, more preferably 10000 or less, in particular preferably 5000 or less. In the meantime, in order to restrain the cured product layer (adhesive layer) sufficiently from undergoing cure shrinkage, the weight-average molecular weight (Mw) of the acrylic oligomer is preferably 500 or more, more preferably 1000 or more, in particular preferably 1500 or more. Specific examples of the (meth)acrylic monomer, from which the acrylic oligomer (A) is made, include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, S-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethyihexyl (meth)acrylate, 4-methyl-2-propylpentyl (meth)acrylate, N-octadecyl (meth)acrylate, and other (C₁-C₂₀)alkyl esters of (meth)acrylic acid; and cycloalkyl (meth)acrylates (such as cyclohexyl (meth)acrylate, and cyclopentyl (meth)acrylate), aralkyl (meth)acrylates (such as benzyl (meth)acrylate), polycyclic (meth)acrylates (such as 2-isobornyl (meth)acrylate, 2-norbornylmethyl (meth)acrylate, 5-norbornene-2-yl-methyl (meth)acrylate, and 3-methyl-2-norbornylmethyl (meth)acrylate), hydroxy-group-containing (meth)acrylates (such as hydroxyethyl (meth)acrylate, 2-hydroxypropyl (meth)acrylate, and 2,3-dihydroxypropylmethyl-butyl (meth)acrylate), alkoxy-group- or phenoxy-group-containing (meth)acrylates (such as 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, and phenoxyethyl (meth)acrylate), epoxy group-containing (meth)acrylates (such as glycidyl (meth)acrylate), halogen-containing (meth)acrylates (such as 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, and heptadecafluorodecyl (meth)acrylate), and alkylaminoalkyl (meth)acrylates (such as dimethylaminoethyl (meth)acrylate). These (meth)acrylates may be used singly or in combination of two or more thereof. Specific examples of the acrylic oligomer (A) include products “ARUFON” manufactured by Toagosei Co., Ltd., “ACTFLOW” manufactured by Soken Chemical & Engineering Co., Ltd., and “JONCRYL” manufactured by BASF Japan Ltd. Out of acrylic oligomers (A) each yielded by polymerizing a (meth)acrylic monomer, an oligomer having a high logPow value is preferred.

### <Optical Acid Generator>

The active-energy-ray-curable adhesive composition may contain an optical acid generator. When the active-energy-ray-curable resin composition contains the optical acid generator, the adhesive layer can be dramatically made better in water resistance and endurance when the composition does not contain any optical acid generator. The optical acid generator can be represented by the following general formula (3):

General Formula (3)

L⁺X⁻ [Formula 6]

wherein L⁺ represents any onium cation, and X⁻ represents a counter ion selected from the group consisting of PF₆⁻, SbF₆⁻, AsF₆⁻, SbCl₆⁻, BiCl₆⁻, SnCl₆⁻, ClO₄⁻, a dithiocarbamate anion, and SCN—.

Out of these anions, which have been given as the examples, anions particularly preferred as the counter anion X⁻ in the general formula (3) are PF₆⁻, SbF₆⁻, and AsF₆⁻. PF₆⁻ and SbF₆⁻ are particularly preferred.

Preferred and specific examples of an onium salt included in the optical acid generator usable in the present invention include products “CYRACURE UVI-6992”, and “CYRACURE UVI-6974” (manufactured by Dow Chemical Japan Ltd.), “ADEKA OPTOMER SP150”, “ADEKA OPTOMER SP152”, “ADEKA OPTOMER SP170”, and “ADEKA OPTOMER SP172” (manufactured by ADEKA Corp.), “IRGACURE 250” (manufactured by Ciba Specialty Chemicals Corp.), “CI-5102”, and “CI-2855” (manufactured by Nippon Soda Co., Ltd.), “SAN-AID SI-60L”, “SAN-AID SI-80L”, “SAN-AID SI-100L”, “SAN-AID SI-110L”, and “SAN-AID SI-180L” (manufactured by Sanshin Chemical Industry Co., Ltd.), “CPI-100P”, and “CPI-100A” (manufactured by San-Apro Ltd.), “WPI-069”, “WPI-113”, “WPI-116”, “WPI-041”, “WPI-044”, “WPI-054”, “WPI-055”, “WPAG-281”, “WPAG-567”, and “WPAG-596” (each manufactured by Wako Pure Chemical Industries, Ltd.).

The content of the optical acid generator is 10 parts or less, preferably from 0.01 to 10 parts, more preferably from 0.05 to 5 parts, in particular preferably from 0.1 to 3 parts by weight for 100 parts by weight of the whole of the curable components.

### <Compound Containing any One of Alkoxy Group and Epoxy Group>

About the active-energy-ray-curable adhesive composition, the optical acid generator may be used together with a compound containing any one of an alkoxy group and an epoxy group in the active-energy-ray-curable adhesive composition.

### (Compound and Polymer Each Having Epoxy Group)

In the case of using a compound having in the molecule thereof one or more epoxy groups, or a polymer having in the molecule thereof two or more epoxy groups (epoxy resin), a compound having in the molecule thereof two or more functional groups reactive with any epoxy group may be used together. Examples of the functional group(s) reactive with any epoxy group include carboxyl, phenolic hydroxyl, mercapto, and primary or secondary aromatic amino groups. The compound in particular preferably has in a single molecule thereof two or more of these functional groups, considering the three-dimensional curability thereof.

The polymer having in the molecule thereof one or more epoxy groups is, for example, an epoxy resin. Examples thereof include bisphenol A type epoxy resin derived from bisphenol A and epichlorohydrin, bisphenol F type epoxy resin derived from bisphenol F and epichlorohydrin, bisphenol S type epoxy resin, phenol novolak type epoxy resin, cresol novolak type epoxy resin, bisphenol A novolak type epoxy resin, bisphenol F novolak type epoxy resin, alicyclic epoxy resin, diphenyl ether type epoxy resin, hydroquinone type epoxy resin, naphthalene type epoxy resin, biphenyl type epoxy resin, fluorene type epoxy resin, polyfunctional epoxy resins such as trifunctional epoxy resin and tetrafunctional epoxy resin, glycidylester type epoxy resin, glycidylamine type epoxy resin, hydantoin type epoxy resin, isocyanurate type epoxy resin, and aliphatic linear epoxy resin. These epoxy resins may be halogenated, and may be hydrogenated. Examples of a commercially available product of the epoxy resin include JER COATs 828, 1001, 801N, 806, 807, 152, 604, 630 and 871, YX8000, YX8034, and YX4000 manufactured by Japan Epoxy Resins Co., Ltd.; EPICLON 830, EXA 835LV, HP 4032D, HP 820 manufactured by DIC Corp.; EP 4100 series, EP 4000 series, and EPU series manufactured by ADEKA Corp.; CELLOXIDE series (2021, 2021P, 2083, 2085, 3000, and others), EPOLEAD series, and EHPE series manufactured by Daicel Corp.; YD series, YDF series, YDCN series, YDB series, and phenoxy resins (YP series and others: polyhydroxypolyethers each synthesized from a bisphenol and epichlorohydrin and having at both ends thereof epoxy groups, respectively) manufactured by Nippon Steel Chemistry Co., Ltd.; DENACOL series manufactured by Nagase ChemteX Corp.; and EPO LIGHT series and others, manufactured by Kyoeisha Chemical Co., Ltd. However, the commercially available epoxy resin product is not limited to these examples. These epoxy resins may be used in combination of two or more thereof.

### (Compound and Polymer Each Having Alkoxy Group)

The compound having in the molecule thereof an alkoxy group is not particularly limited as far as the compound is a compound having in the molecule thereof one or more alkoxy groups. The compound may be any known compound. Typical examples of the compound include a melamine compound, an amino resin, and a silane coupling agent.

The blend amount of the compound containing any one of an alkoxy group and an epoxy group is usually 30 parts or less by weight for 100 parts by weight of the whole of the curable components. If the content of the compound in the composition is too large, the adhesive composition is lowered in adhesion, so that the impact resistance thereof may be deteriorated in a dropping test. The content of the compound in the composition is more preferably 20 parts or less by weight. In the meantime, the composition contains the compound in an amount that is preferably 2 parts or more, more preferably 5 parts or more by weight from the viewpoint of the water resistance of the composition.

### <Compound Having Vinyl Ether Group>

The adhesive composition usable in the present invention may contain a compound having a vinyl ether group. This case is favorable since the polarizer and the resultant adhesive layer are improved in adhesion water-resistance therebetween. Reasons why this advantageous effect is gained are unclear; however, it is presumed that one of the reasons is as follows: the vinyl ether group, which the compound has, interacts with the polarizer to heighten the adhering strength between the polarizer and the adhesive layer. In order to heighten the polarizer and the adhesive layer further in adhesion water-resistance therebetween, the compound is preferably a radical polymerizable compound having a vinyl ether group. The content of the compound is preferably from 0.1 to 19 parts by weight for 100 parts by weight of the whole of the curable components.

### <Keto-Enol Tautomerism Generable Compound>

A compound in which keto-enol tautomerism is generable may be incorporated into the adhesive composition usable in the present invention. It is preferred to use, for example, an embodiment in which this keto-enol tautomerism generable compound is contained in the adhesive composition that contains a crosslinking agent or that is usable in the state of blending a crosslinking agent into the composition. This embodiment allows to restrain the adhesive composition after the blending of the organometallic compound into the composition from being excessively raised in viscosity or gelatinized and from undergoing the production of a micro-gelatinized product, so as to realize an effect of prolonging the pot life of this composition.

The keto-enol tautomerism generable compound may be a β-dicarbonyl compound that may be of various types. Specific examples thereof include acetylacetone, 2,4-hexanedione, 3,5-heptanedione, 2-methylhexane-3,5-dione, 6-methylheptane-2,4-dione, 2,6-dimethylheptane-3,5-dione, and other 3-diketones; methyl acetoacetate, ethyl acetoacetate, isopropyl acetoacetate, tert-butyl acetoacetate, and other acetoacetates; ethyl propionylacetate, ethyl propionylacetate, isopropyl propionylacetate, tert-butyl propionylacetate, and other propionylacetates; ethyl isobutyrylacetate, ethyl isobutyrylacetate, isopropyl isobutyrylacetate, tert-butyl isobutyrylacetate, and other isobutyrylacetates; and methyl malonate, ethyl malonate, and other malonates. Out of these examples, acetylacetone and acetoacetates are preferred compounds. These keto-enol tautomerism generable compounds may be used singly or in combination of two or more thereof.

The use amount of the keto-enol tautomerism generable compound(s) may be, for example, from 0.05 to 10 parts, preferably from 0.2 to 3 parts (for example, from 0.3 to 2 parts) by weight per part by weight of the organometallic compound. If the use amount of the compound(s) is less than 0.05 parts by weight per part by weight of the organometallic compound, the use effects thereof may not be sufficiently exhibited with ease. In the meantime, if the use amount of the compound(s) is more than 10 parts by weight per part by weight of the organometallic compound, the compound interacts excessively with the organometallic compound so that a target water resistance may not be easily expressed.

<Additives Other than Above-Mentioned Components>

Various additives may be blended, as other optional components, into the adhesive composition usable in the present invention as far as the object and advantageous effects of the invention are not damaged. Examples of the additives include epoxy resin, polyamide, polyamideimide, polyurethane, polybutadiene, polychloroprene, polyether, polyester, styrene-butadiene block copolymer, petroleum resin, xylene resin, ketone resin, cellulose resin, fluorine-contained oligomer, silicone-based oligomer, BR>A polysulfide-based oligomer, and other polymers or oligomers; phenothiazine, 2,6-di-t-butyl-4-methylphenol, and other polymerization inhibitors; polymerization initiation aids; leveling agents; wettability improvers; surfactants; plasticizers; ultraviolet absorbers; inorganic fillers; pigments; and dyes.

The amount of the additives is usually from 0 to 10 parts, preferably from 0 to 5 parts, most preferably from 0 to 3 parts by weight for 100 parts by weight of the whole of the curable components.

### <Viscosity of Adhesive Composition>

The viscosity of the adhesive composition usable in the present invention is preferably 100 cps or less at 25° C. from the viewpoint of the applicability thereof. In the meantime, if the adhesive composition, for polarizing films, in the invention is more than 100 cp at 25° C., the temperature of the adhesive composition may be controlled when the composition is applied, so as to adjust the viscosity thereof to 100 cp or less. The thus obtained composition is usable. The viscosity ranges more preferably from 1 to 80 cp, most preferably from 10 to 50 cp. The viscosity is measurable, using an E-type viscometer TVE22LT manufactured by Toki Sangyo Co., Ltd.

In the adhesive composition usable in the present invention, it is preferred to use, as one of the curable components, a material low in skin irritation from the viewpoint of safety. The skin irritation can be judged, using an index of P.I.I. The P.I.I is widely used as an index showing the degree of skin disorder, and is measured by a Draize method. The measured value thereof is represented in a range from 0 to 8. As this value is smaller, the irritation is judged to be lower. However, the measured value includes a large accidental error; thus, it is advisable to understand this index as a reference value. The P.I.I is preferably 4 or less, more preferably 3 or less, most preferably 2 or less.

### <Bulk Water Absorption Coefficient>

About the adhesive composition usable in the present invention, the bulk water absorption coefficient is preferably 10% or less by weight, the bulk water absorption coefficient being measured when a cured product yielded by curing the curable adhesive composition is immersed in water of 23° C. temperature for 24 hours. When the polarizing film is put in a severe environment of a high temperature and a high humidity (for example, at 85° C. and 85% RH), water that has permeated the transparent protective film and the adhesive layer invades the polarizer so that the crosslinked structure thereof is hydrolyzed. Thus, the orientation of its dichroic dye is disturbed so that the polarizing film is deteriorated in optical endurances, for example, the polarizing film is raised in transmittance and is lowered in polarization degree. By setting the bulk water absorption coefficient of the adhesive layer to 10% or less by weight, the shift of water into the polarizer is restrained when the polarizing film is put in a severe environment of a high temperature and a high humidity. Consequently, the polarizing film can be restrained from being raised in transmittance and being lowered in polarization degree. About the adhesive composition of the polarizing film, the bulk water absorption coefficient is preferably 5% or less, more preferably 3% or less, most preferably 1% or less by weight to make the polarizing film better in optical endurances in a severe environment of a high temperature and a high humidity. In the meantime, when the polarizer and the transparent protective film are bonded to each other, the polarizer keeps water in a predetermined quantity. Thus, when the curable adhesive composition contacts water contained in the polarizer, the polarizing film may undergo the generation of external appearance defects, such as repellence and air foams. In order to restrain the external appearance defects, it is preferred that the curable adhesive composition can absorb a predetermined quantity of water. More specifically, the bulk water absorption coefficient is preferably 0.01% or more, more preferably 0.05% or more by weight. The bulk water absorption coefficient is measured specifically by a water absorption coefficient measuring method described in JISK 7209.

### <Cure Shrinkage Percentage>

The adhesive composition usable in the present invention has the above-mentioned curable component(s); thus, when the curable adhesive composition is cured, the composition usually undergoes cure shrinkage. The cure shrinkage percentage thereof is the following index when an adhesive layer is made of/from the curable adhesive composition for polarizing films: an index showing the proportion of cure shrinkage of the adhesive layer. When the cure shrinkage percentage of the adhesive layer becomes large, a favorable result is gained to restrain the matter that when the curable adhesive composition for polarizing films is cured to form the adhesive layer, interfacial strain is generated to cause bonding poorness. From this viewpoint, the above-mentioned cure shrinkage percentage is preferably 10% or less, this percentage being related to a cured product yielded by curing the curable adhesive composition, for polarizing films, in the present invention. It is preferred that the cure shrinkage percentage is small. The cure shrinkage percentage is preferably 8% or less, more preferably 5% or less. The cure shrinkage percentage is measured by a method described in JP-A-2013-104869, specifically, a method using a cure shrinkage sensor manufactured by SENTEC Co., Ltd.

### <Polarizing Film>

The polarizing film in the present invention is a film in which a transparent protective film is bonded to at least one surface of a polarizer, the surface being an adhesive-layer-laid surface subjected to an activating treatment, so as to interpose, between the transparent protective film and the surface, an adhesive layer that is formed in the form of a cured product layer of the above-defined adhesive composition. As described above, the adhesive layer, which is the cured product layer, preferably has a bulk water absorption coefficient of 10% or less by weight.

### <Adhesive Layer>

The thickness of the adhesive layer, which is made of/from the curable adhesive composition, is preferably controlled into the range of 0.1 to 3 μm. The thickness of the adhesive layer is preferably from 0.3 to 2 μm, more preferably from 0.5 to 1.5 μm. When the thickness of the adhesive layer is set to 0.1 μm or more, a favorable result is gained to restrain the generation of adhesion poorness by cohesive strength of the adhesive layer, and the generation of an external appearance defect (air foaming) when the transparent protective film and the polarizer are laminated to each other. In the meantime, if the thickness of the adhesive layer is larger than 3 μm, the pressure-sensitive-adhesive layer attached polarizing film may not unfavorably satisfy endurance.

About the curable adhesive composition, any adhesive layer that is made of/from this composition preferably has a Tg selected to be 60° C. or higher. The Tg is more preferably 70° C. or higher, even more preferably 75° C. or higher, even more preferably 100° C. or higher, even more preferably 120C or higher. In the meantime, if the Tg of the adhesive layer is too high, the polarizing film is lowered in bendability. Thus, the Tg of the adhesive layer is more preferably 300° C. or lower, even more preferably 240° C. or lower, even more preferably 180° C. or lower. The Tg <glass transition temperature> is measured using a dynamic viscoelasticity measuring instrument RSA III manufactured by a company TA Instruments under the following measuring conditions:

Sample size: 10 mm in width and 30 mm in length,

Clamp distance: 20 mm,

Measuring mode: tension, Frequency: 1 Hz, and Temperature-raising rate: 5° C./minute. The dynamic viscoelasticity of a sample is measured, and the temperature of a peak top of the tan δ thereof is adopted as the Tg of the sample.

About the curable resin composition, the adhesive layer that is made of/from this composition preferably has a storage modulus of 1.0×10⁷ Pa or more at 25° C. The storage modulus is more preferably 1.0×10⁸ Pa or more. For reference, the storage modulus of a pressure-sensitive-adhesive layer is from 1.0×10³ to 1.0×10⁸ Pa, and is different from that of the adhesive layer. When the pressure-sensitive-adhesive layer attached polarizing film is subjected to heat cycles (for example, from −40 to 80° C.), the storage modulus of the adhesive layer affects cracking in the polarizer; thus, when the storage modulus is low, an inconvenience of the polarizer-cracking is easily generated. The range of temperatures at which the adhesive layer has a high storage modulus is preferably 80° C. or lower, most preferably 90° C. or lower. At the same time of measuring the Tg <glass transition temperature>, the storage modulus is measured using the dynamic viscoelasticity measuring instrument RSA III manufactured by the company TA Instruments under the same conditions. The dynamic viscoelasticity of a sample is measured, and the storage modulus (E′) value thereof is adopted.

The polarizing film related to the present invention can be produced by a method for producing a polarizing film in which a transparent protective film is laid on/over at least one surface of a polarizer to interpose an adhesive layer between the surface and the transparent protective film, this method including the following: a step of subjecting an adhesive-layer-laying-planned surface of the polarizer to an activating treatment; an applying step of applying an adhesive composition including an active-energy-ray-curable component, and a shrinkage inhibitor having a structural formula having an M-O bond wherein M is silicon, titanium, aluminum or zirconium, and O represents an oxygen atom to a surface of at least one of the polarizer and the transparent protective film; a bonding step of bonding the polarizer and the transparent protective film to each other; and an adhering step of radiating an active energy ray to the resultant workpiece from a polarizer surface side of the workpiece or a transparent protective film surface side of the workpiece to cure the adhesive composition to yield the adhesive layer, and causing the polarizer and the transparent protective film to adhere to each other through the yielded adhesive layer. In this producing method, it is preferred that the polarizer has a water content of 8 to 19% in the adhering step.

Before the application of the curable resin composition, the transparent protective film may be subjected to an activating treatment in the same manner as the polarizer.

The manner of applying the curable resin composition is appropriately selected in accordance with the viscosity of the composition, and a target thickness of the resultant layer. Examples of the applying manner include a reverse coater, a (direct, revere or offset) gravure coater, a bar reverse coater, a roll coater, a die coater, a bar coater, and a rod coater. Furthermore, for the application, a dipping manner or some other manner is appropriately usable.

The polarizer and the transparent protective film are bonded to each other to interpose, therebetween, the curable resin composition applied as described above. The bonding of the polarizer and the transparent protective film to each other can be attained, using, for example, a roll laminator.

### <Curing of Adhesive Composition>

The curable resin composition used in the present invention is preferably used as an active-energy-ray-curable adhesive composition. The active-energy-ray-curable adhesive composition is usable in an electron beam curable, ultraviolet curable or visible ray curable form. The form of the curable adhesive composition is preferably a visible ray curable adhesive composition from the viewpoint of the producibility thereof.

### <<Active Energy Ray Curable Form>>

According to the active-energy-ray-curable adhesive composition, a polarizer and a transparent protective film are bonded to each other, and subsequently the resultant workpiece is irradiated with an active energy ray (such as an electron beam, an ultraviolet ray or a visible ray) to cure the active-energy-ray-curable adhesive composition to form an adhesive layer. A direction along which the active energy ray (which is, for example, an electron beam, an ultraviolet ray or a visible ray) is radiated may be any appropriate radiating direction. Preferably, the active energy ray is radiated from the transparent protective film side of the workpiece. If the active energy ray is radiated from the polarizer side thereof, the polarizer may be unfavorably deteriorated by the active energy ray (which is, for example, an electron beam, an ultraviolet ray or a visible ray).

### <<Electron Beam Curable Form>>

About the electron beam curable form, conditions for radiating an electron beam may be arbitrarily-selected appropriate conditions as far as the conditions are conditions under which the active-energy-ray-curable adhesive composition is curable. About the electron beam radiation, for example, the accelerating voltage is preferably from 5 to 300 kV, more preferably from 10 to 250 kV. If the accelerating voltage is less than 5 kV, the electron beam may not reach the adhesive so that the adhesive may not be unfavorably cured sufficiently. If the accelerating voltage is more than 300 kV, the penetrating power of the beam into a sample is too strong, so that the beam may unfavorably damage its transparent protective film or polarizer. The radiation ray quantity thereof is from 5 to 100 kGy, more preferably from 10 to 75 kGy. If the radiation ray quantity is less than 5 kGy, the adhesive is insufficiently cured. If the quantity is more than 100 kGy, the transparent protective film or the polarizer is damaged, so that the resultant polarizing film is lowered in mechanical strength or yellowed not to gain predetermined optical properties.

The electron beam radiation is usually performed in an inert gas. If necessary, the radiation may be performed in the atmospheric air or under conditions that a small amount of oxygen is introduced into an inert gas. An appropriate introduction of oxygen dares to cause oxygen blocking in a surface of the transparent protective film onto which the electron beam is to be initially radiated, so that the beam can be prevented from damaging the transparent protective film to radiate the electron beam effectively only to the adhesive although this matter depends on the material of the transparent protective film.

### <<Ultraviolet Curable Form and Visible Ray Curable Form>>

In a method for producing the polarizing film according to the present invention, it is preferred to use, as active energy rays, rays including visible rays having wavelengths ranging from 380 to 450 nm, particularly, active energy rays in which the radiation quantity of visible rays having wavelengths ranging from 380 to 450 nm is the largest. When a transparent protective film to which ultraviolet ray absorbing power is given (ultraviolet non-transmissible type transparent protective film) is used about ultraviolet curability or visible ray curability, the transparent protective film absorbs light rays having wavelengths shorter than about 380 nm; thus, the light rays having wavelengths shorter than 380 nm do not reach the active-energy-ray-curable adhesive composition not to contribute to a polymerization reaction of the composition. Furthermore, the light rays having wavelengths shorter than 380 nm, which are absorbed by the transparent protective film, are converted to heat, so that the transparent protective film itself generates heat. The heat causes defects of the polarizing film, such as a curling or wrinkles of the film. Thus, in the case of adopting, in the present invention, an ultraviolet curable or visible ray curable form, it is preferred to use, as an active energy ray generating device, a device which does not emit light rays shorter than 380 nm. More specifically, therein, the ratio of the integrated illuminance of light rays having a wavelength range from 380 to 440 mm to that of light rays having a wavelength range from 250 to 370 nm is preferably from 100/0 to 100/50, more preferably from 100/0 to 100/40. For the active energy ray related to the present invention, preferred is a gallium sealed metal halide lamp, or an LED light source emitting light rays having a wavelength range from 380 to 440 nm. Alternatively, a light source including ultraviolet rays and visible rays is usable, examples of which include a low pressure mercury lamp, a middle pressure mercury lamp, a high pressure mercury lamp, a super high pressure mercury lamp, an incandescent lamp, a xenon lamp, a halogen lamp, a carbon arc lamp, a metal halide lamp, a fluorescent lamp, a tungsten lamp, a gallium lamp, an excimer laser, and sunlight. It is allowable to use light rays about which a bandpass filter is used to block ultraviolet rays having wavelengths shorter than 380 nm. In order to heighten the adhesive performance of the adhesive layer between the polarizer and the transparent protective film, and simultaneously prevent the polarizing film from being curled, it is preferred to use an active energy ray obtained by using a gallium sealed metal halide lamp and further passing light therefrom through a bandpass filter which can block light rays having wavelengths shorter than 380 nm, or use an active energy ray having a wavelength of 405 nm, which is obtained by using an LED light source.

In the ultraviolet curable or visible ray curable form, it is preferred to heat the active-energy-ray-curable adhesive composition before the radiation of ultraviolet rays or visible rays (heating before radiation) to the composition. In this case, the composition is heated preferably to 40° C. or higher, more preferably to 50° C. or higher. It is also preferred to heat the active-energy-ray-curable adhesive composition after the radiation of ultraviolet rays or visible rays (heating after radiation) thereto. In this case, the composition is heated preferably to 40° C. or higher, more preferably to 50° C. or higher.

The adhesive composition used in the present invention is favorably usable, particularly, when an adhesive layer is formed for bonding a polarizer to a transparent protective film about which the transmittance of light rays having a wavelength of 365 nm is less than 5%. At this time, the adhesive composition used in the invention may include a photopolymerization initiator of the general formula (1); in this case, by radiating ultraviolet rays to the composition across the transparent protective film having UV absorbing power, the composition can be cured to form the adhesive layer. Thus, also in a polarizing film in which transparent protective films having UV absorbing power are laminated, respectively, onto both surfaces of a polarizer, its adhesive layers can be cured. Naturally, however, also in a polarizing film in which transparent protective films having no UV absorbing power are laminated thereto, its adhesive layers can be cured. The wording “transparent protective film having UV absorbing power” means a transparent protective film about which the transmittance of a light ray having a wavelength of 380 nm is less than 10%.

The method for giving UV absorbing power to a transparent protective film may be a method of incorporating an ultraviolet absorbent into the transparent protective film, or a method of laminating a surface treatment layer containing an ultraviolet absorbent onto a surface of the transparent protective film.

Specific examples of the ultraviolet absorbent include oxybenzophenone-based compounds, benzotriazole-based compounds, salicylate-based compounds, benzophenone-based compounds, cyanoacrylate-based compounds, nickel complex salt type compounds, and triazine-based compounds, which are known in the prior art.

After the polarizer and the transparent protective film are bonded to each other, the active-energy-ray-curable adhesive composition is irradiated with an active energy ray (such as an electron beam, an ultraviolet ray or a visible ray) to be cured to form an adhesive layer. A direction along which the active energy ray (which is, for example, an electron beam, an ultraviolet ray or a visible ray) is radiated may be any appropriate radiating direction. Preferably, the active energy ray is radiated from the transparent protective film side of the workpiece. If the active energy ray is radiated from the polarizer side thereof, the polarizer may be unfavorably deteriorated by the active energy ray (which is, for example, an electron beam, an ultraviolet ray or a visible ray).

When the polarizing film according to the present invention is produced in a continuous line, the line speed, which depends on the curing period of the adhesive composition, is preferably from 1 to 500 m/min., more preferably from 5 to 300 m/min., even more preferably from 10 to 100 m/min. If the line speed is too small, the producing system is small in producing performance, or the transparent protective film is excessively damaged, so that no polarizing film that can endure an endurance test or the like can be produced. If the line speed is too large, the adhesive composition is insufficiently cured so that the composition may not gain a target adhesion.

In the polarizing film of the present invention, a polarizer and a transparent protective film are bonded to each other to interpose, therebetween, an adhesive layer made in the form of a cured product layer of the above-mentioned active-energy-ray-curable adhesive composition. Between the transparent protective film and the adhesive layer, an easily adhesive layer may be disposed. The easily adhesive layer can be formed, using a resin that may be of various types. This resin has, for example, a polyester, polyether, polycarbonate, polyurethane, silicone type, polyamide, polyimide or polyvinyl alcohol skeleton. These polymeric resins may be used singly or in any combination of two or more thereof. In the formation of the easily adhesive layer, a different additive may be added thereto. Specifically, for example, the following may be further used: a tackifier, an ultraviolet absorbent, an antioxidant, a heat-resistant stabilizer, and other stabilizers.

The easily adhesive layer is usually laid on the transparent protective film in advance, and the easily adhesive layer side of the transparent protective film and the polarizer are bonded to each other through an adhesive layer. The formation of the easily adhesive layer is attained by applying a material for forming the easily adhesive layer onto the transparent protective film, and then drying the resultant according to a known technique. The material for forming the easily adhesive layer is usually prepared in the form of a solution in which the concentration of the material is diluted into an appropriate concentration, considering the thickness of the material-dried layer, the smoothness of the applying, and others. The thickness of the dried easily adhesive layer is preferably from 0.01 to 5 μm, more preferably from 0.02 to 2 μm, even more preferably from 0.05 to 1 μm. Plural easily adhesive layers may be laid. In this case also, however, the total thickness of the easily adhesive layers is set preferably into any one of these ranges.

### <Transparent Protective Film>

A material for forming the transparent protective film laid on/over one or each of both surfaces of the above-defined polarizer is preferably a material excellent in transparency, mechanical strength, thermal stability, water blocking performance, isotropy and others. Examples of the material include polyester-based polymers, such as polyethylene terephthalate and polyethylene naphthalate, cellulose-based polymers such as diacetylcellulose and triacetylcellulose, acrylic polymers such as polymethyl methacrylate, styrene-based polymers such as polystyrene and acrylonitrile/styrene copolymer (AS resin), and polycarbonate-based polymers. Other examples of the polymer which the transparent protective film is made of include polyethylene, polypropylene, polyolefins each having a cyclic or norbornene structure, polyolefin-based polymers such as ethylene/propylene copolymer, vinyl chloride-based polymers, amide-based polymers such as nylon and aromatic polyamide, imide-based polymers, sulfone-based polymers, polyethersulfone-based polymers, polyetheretherketone-based polymers, polyphenylene sulfide-based polymers, vinyl alcohol-based polymers, vinylidene chloride-based polymers, vinyl butyral-based polymers, arylate-based polymers, polyoxymethylene-based polymers, and epoxy-based polymers; and any blend composed of two or more of these polymers. The transparent protective film may contain one or more appropriate additives selected at will. Examples of the additive(s) include an ultraviolet absorbent, an antioxidant, a lubricant, a plasticizer, a release agent, a coloring preventive, a flame retardant, a nucleating agent, an antistatic agent, a pigment and a colorant. The content of one or more of the above-mentioned thermoplastic resins in the transparent protective film is preferably from 50 to 100%, more preferably from 50 to 99%, even more preferably from 60 to 98%, in particular preferably from 70 to 97% by weight. If the content of the thermoplastic resin(s) in the transparent protective film is 50% or less by weight, it is feared that the transparent protective film cannot sufficiently express high transparency and other properties which the thermoplastic resin(s) originally has/have.

The transparent protective film may be a polymer film described in JP-A-2001-343529 (WO 01/37007), for example, a resin composition including a thermoplastic resin (A) having at a side chain thereof a substituted and/or unsubstituted imide group(s) and a thermoplastic resin (B) having at a side chain thereof a substituted and/or unsubstituted phenyl(s), and a nitrile group. A specific example thereof is a film of a resin composition including an alternating copolymer made from isobutylene and N-methylmaleimide, and acrylonitrile/styrene copolymer. The film may be a film made of, for example, a blend extruded product of the resin composition. Such a film is small in retardation, and small in photoelastic coefficient; thus, this film can solve inconveniences, such as an unevenness of the polarizing film that is based on strains in the film. Moreover, the film is small in moisture permeability to be excellent in humidity endurance.

In the polarizing film, the transparent protective film preferably has a moisture permeability of 5 to 70 g/m²/24-hours. This structure is difficult for water in the air to enter the inside of the pressure-sensitive-adhesive layer attached polarizing film, so that the pressure-sensitive-adhesive layer attached polarizing film itself can be restrained from being changed in water content by percentage. As a result, the pressure-sensitive-adhesive layer attached polarizing film can be restrained from being curled or changed in dimension in accordance with an environment in which this film is stored.

Examples of a material for forming the transparent protective film satisfying the above-mentioned low moisture permeability include polyester polymers, such as polyethylene terephthalate and polyethylene naphthalate; polycarbonate resins; arylate-based resins; amide-based resins such as nylon and aromatic polyamide; polyolefin-based polymers such as polyethylene, polypropylene and ethylene/propylene copolymer, cyclic olefin resins having a cyclic or norbornene structure, and (meth)acrylic resins; and mixtures each made of two or more of these resins. Out of these resins, preferred are polycarbonate-based resins, cyclic polyolefin-based resins and (meth)acrylic resins, and particularly preferred are cyclic polyolefin-based resins and (meth)acrylic resins.

The thickness of the transparent protective film may be appropriately decided, and is generally from about 1 to 100 μm, in particular preferably from 1 to 80 μm, more preferably from 3 to 60 μm from the viewpoint of the strength, the handleability and other workabilities of the film, thin-layer properties of the film, and other factors.

When transparent protective films are laid, respectively, on both surfaces of the polarizer, it is allowable to use transparent protective films made of the same polymeric material on the front and rear surfaces, or use transparent protective films different from each other on the surfaces.

A function layer may be laid on the non-polarizer-bonded surface of (each of) the transparent protective film(s). Examples of the function layer include a hard coat layer, an anti-reflection layer, a sticking preventing layer, a diffusion layer, and an anti-glare layer. The function layer, which is, for example, a hard coat layer, an anti-reflection layer, a sticking preventing layer, a diffusing layer or an anti-glare layer, may be laid on the transparent protective film itself or, may be laid in the form of a body separate from the transparent protective film.

### <Optical Film>

When put into practical use, the polarizing film in the present invention is usable in the form of an optical film in which the polarizing film is laminated onto another optical film. The optical film is not particularly limited. Examples thereof include a reflector, a transreflector, retardation plates (for example, a wavelength plates such as a half wavelength plate and a quarter wavelength plate), and a viewing angle compensation film, and other layers usable to form a liquid crystal display or the like. These optical films may be used singly or in the form of two or more layers thereof. The polarizing film in the present invention is in particular preferably a reflection type polarizing film in which a reflector or a transreflector is further laminated on any polarizing film in the invention, an elliptically or circularly polarizing film in which a retardation plate is further laminated on the polarizing film, a wide viewing angle polarizing film in which a viewing angle compensation film is further laminated on the polarizing film, or a polarizing film in which a brightness enhancement film is further laminated on the polarizing film.

An optical film in which optical films as described above are laminated onto the polarizing film may be formed in such a manner that the layers are successively and individually laminated onto each other in a process for producing, for example, a liquid crystal display. An optical film prepared by laminating the layers beforehand onto each other is excellent in quality stability, fabricating workability and others to have an advantage of improving a process for producing, for example, a liquid crystal display. For the laminating, a pressure-sensitive-adhesive layer or any other appropriate adhesive means may be used. In the bonding of the polarizing film or the other optical film(s), the optical axis thereof may be adjusted to have an appropriate location angle in accordance with, for example, a target retardation property.

### <Pressure-Sensitive-Adhesive Layer>

In the above-mentioned polarizing film, or an optical film in which at least one polarizing film is laminated, a pressure-sensitive-adhesive layer may be laid for bonding this polarizing film or optical film onto a different member such as a liquid crystal cell. A pressure-sensitive-adhesive agent which forms the pressure-sensitive-adhesive layer is not particularly limited. This agent may be appropriately selected from the following, and then used: pressure-sensitive-adhesive agents each containing, as a base polymer thereof, an acrylic polymer, silicone-based polymer, polyester, polyurethane, polyamide, polyether, fluorine-containing polymer, rubbery polymer, or some other polymer. The pressure-sensitive-adhesive agent is in particular preferably an acrylic pressure-sensitive-adhesive, or any other pressure-sensitive-adhesive that is excellent in optical transparency, and shows adherabilities of appropriate wettability, cohesive property and adhesion to be excellent in weather resistance, heat resistance and others.

Pressure-sensitive-adhesive layers may be laid, as superimposed layers different from each other in, for example, composition or species, onto a single surface or each surface of the polarizing film or the optical film. When pressure-sensitive-adhesive layers are laid, respectively, onto both surfaces of the polarizing film or optical film, these layers may be different from each other in, for example, composition, species or thickness on the front and rear side of the film. The thickness of (each of) the pressure-sensitive-adhesive layer(s) may be appropriately decided in accordance with, for example, the use purpose and adhering strength thereof. The thickness is generally from 1 to 500 μm, preferably from 1 to 200 μm, in particular preferably from 1 to 100 μm.

A separator is temporarily bonded to a naked surface of the pressure-sensitive-adhesive layer to cover the surface in order to attain the prevention of the pollution of the surface, and other purposes until this layer is put into practical use. This coverage can prevent any person or object from contacting the pressure-sensitive-adhesive layer in an ordinarily handled state thereof. The separator may be an appropriate separator according to conventional techniques except the above-mentioned thickness conditions, examples of the separator including a plastic film, a rubber sheet, a paper, cloth or nonwoven cloth piece, a net, a foamed sheet or a metal foil piece; a laminated body of such flat pieces; or a product in which such a flat piece is optionally subjected to coating treatment with an appropriate release agent, such as a silicone type, long-chain alkyl type or fluorine-containing type agent, or molybdenum sulfide.

### <Image Display>

The polarizing film or optical film of the present invention is preferably usable to form various devices such as a liquid crystal display. The formation of the liquid crystal display may be attained in accordance with the prior art. In other words, any liquid crystal display is generally formed, for example, by: fabricating appropriately a liquid crystal cell and a polarizing film or optical film, and further other optional constituent parts such as an optional lighting system; and then integrating a driving circuit into the resultant. In the present invention, the method for the formation is not particularly limited except that the use of the polarizing film or optical film according to the invention. Thus, the method is substantially according to the prior art. The liquid crystal cell may be also of any type, such as a TN type, STN type or π type.

An appropriate liquid crystal display may be formed, examples thereof including a liquid crystal display in which a polarizing film or optical film is arranged onto one or each of both sides of a liquid crystal cell, and a liquid crystal display in which a backlight or reflector is used as a lighting system. In this case, any polarizing film or optical film according to the present invention can be set on one or each of both the sides of the liquid crystal cell. When polarizing films or optical films of the invention are set up, respectively, on both the sides, these may be the same as or different from each other. When the liquid crystal display is formed, one or more appropriate components may be further arranged, at one or more appropriate positions of the device, in the form of one or two or more layers of the component(s), examples of the component(s) including a diffusing plate, an anti-glare layer, an anti-reflection film, a protective plate, a prism array, a lens array sheet, a light diffusing plate, and a backlight.

### EXAMPLES

Hereinafter, working examples of the present invention will be described. However, embodiments of the invention are not limited thereto.

### <Production of Each Polarizer>

A 45-μm-thickness film of a polyvinyl alcohol having an average polymerization degree of 2400 and a saponification degree of 99.9% by mol was immersed in hot water of 30° C. temperature for 60 seconds to be swollen. Next, the film was immersed in an aqueous solution of iodine and potassium iodide (ratio by weight=0.5/8), the concentration thereof being 0.3%, and the film was dyed therewith while stretched into a length 3.5 times the original length. Thereafter, the film was stretched in an aqueous solution of a boric acid that had a temperature of 65° C. to give a total stretch ratio of 6. After the stretching, the film was dried in an oven of 40° C. temperature for 3 minutes. In this way, each PVA-based polarizer 1 (thickness: 18 μm) was yielded.

In order to produce each PVA-based polarizer 2, a laminate in which a PVA layer of 24 μm thickness was formed on an amorphous PET substrate was initially subjected to in-air auxiliary stretching at a stretching temperature of 130° C. to produce a stretched laminate. Next, the stretched laminate was dyed to produce a colored laminate, and further the colored laminate was stretched in an aqueous solution of boric acid at a stretching temperature of 65 degrees to give a total stretch ratio of 5.94. In this way, an optical film laminate was produced which included a 10-μm-thick PVA layer integrated with the amorphous PET substrate. By the two-stage stretching, the PVA-based polarizer 2, the thickness of which was 5 μm, was yielded, in which PVA molecules in the PVA layer formed on the amorphous PET substrate were aligned at a high level, and iodine adsorbed by the dyeing was aligned, in the form of a polyiodine ion complex, into one direction at a high level.

A 60-μm-thick polyvinyl alcohol film having an average polymerization degree of 2400 and a saponification degree of 99.9% by mole was immersed in hot water of 30° C. temperature for 60 seconds to be swollen. Next, the resultant was immersed in an aqueous solution of iodine/potassium iodine (ratio by weight=0.5/8) that had a concentration of 0.3%. While this workpiece was stretched into a stretch ratio of 3.5, the film was dyed. Thereafter, the workpiece was stretched in an aqueous solution of a borate of 65° C. temperature to give a total stretch ratio of 6. After the stretching, the workpiece was dried in an oven of 40° C. temperature for 3 minutes. In this way, each PVA-based polarizer 3 (thickness: 23 μm) was yielded.

When an activating treatment was applied to an adhesive-layer-laying-planned surface of any one of the PVA-based polarizers 1 to 3, a corona radiating device (CT-0212, manufactured by Kasuga Electric Works Ltd.) was used to apply corona treatment at a discharged capacity of 40 W/m²/min. to both surfaces of the polarizer to plasticize the surfaces of the polarizer.

### <Each Transparent Protective Film>

Each transparent protective film: each film was used which was yielded by applying corona treatment to a 40-μm-thick (meth)acrylic resin film (moisture permeability: 64 g/m²/24-hours) under the same conditions as described above.

### <Moisture Permeability of Transparent Protective Film>

The moisture permeability of the transparent protective film was measured in accordance with a moisture permeability test (cup method) in JIS Z0208. A sample yielded by cutting the film into a 60-mm-diameter form was set in a moisture permeable cup in which about 15 g of calcium chloride was put. The cup was put in a thermostat of 40° C. temperature and 92% R.H., and then allowed to stand still for 24 hours. Before and after the still-standing, an increase of the calcium chloride in weight was measured. In this way, the moisture permeability (g/m²/24-hours) was measured.

### <Active Energy Rays>

As active energy rays, visible rays (gallium-sealed metal halide lamp) were used. Radiating device: Light HAMMER 10, manufactured by Fusion UV Systems, Inc. Bulb: V bulb. Peak irradiance: 1600 mW/cm². Integrated radiated-light quantity: 1000/mJ/cm² (wavelengths: 380 to 440 nm). The irradiance of the visible rays was measured, using a Sola-Check system manufactured by Solatell Ltd.

### (Preparation of Adhesive Compositions 1 to 21)

Adhesive compositions 1 to 21 were each yielded by individual components with each other in accordance with a blend table described in Table 1.

TABLE 1

| | | | | | | Shrinkage inhibitors | | | | | |
|---|---|---|---|---|---|---|---|---|---|---|---|
| | | | | | | | | | Organometallic compounds | | |
| | Active-energy-ray-curable component | | | | | Organosilicon compounds | | | | | Aluminum |
| | HEAA | ACMO | 1,9N-DA | M-220 | UP-1190 | KBM602 | KBM603 | KBM903 | D20 | ZA65 | chelate M |
| Adhesive 1 | 12.5 | 39.5 | 48.0 | | | | | | 0.5 | | |
| Adhesive 2 | 12.5 | 39.5 | 48.0 | | | | | | | 1.0 | |
| Adhesive 3 | 12.5 | 39.5 | 48.0 | | | | | | | | 1.0 |
| Adhesive 4 | 12.5 | 39.5 | 48.0 | | | | | | | | |
| Adhesive 5 | 12.5 | 39.5 | 48.0 | | | | | | | | |
| Adhesive 6 | 12.5 | 39.5 | 48.0 | | | | | | | | |
| Adhesive 7 | 12.5 | 39.5 | 48.0 | | | | | | | | |
| Adhesive 8 | 12.5 | 39.5 | 48.0 | | | | | | | | |
| Adhesive 9 | 12.5 | 39.5 | 48.0 | | | | | | | | |
| Adhesive 10 | 12.5 | 39.5 | 48.0 | | | | | | | | |
| Adhesive 11 | 11.2 | 11.2 | | 55.8 | 11.2 | | | | | | |
| Adhesive 12 | 11.2 | 11.2 | | 55.8 | 11.2 | | | | | | |
| Adhesive 13 | 11.2 | 11.2 | | 55.8 | 11.2 | | | | | | |
| Adhesive 14 | 11.2 | 11.2 | | 55.8 | 11.2 | | | | | | |
| Adhesive 15 | 11.2 | 11.2 | | 55.8 | 11.2 | | | | | | |
| Adhesive 16 | 11.2 | 11.2 | | 55.8 | 11.2 | | | | 3.0 | | |
| Adhesive 17 | 11.2 | 11.2 | | 55.8 | 11.2 | 3.0 | | | | | |
| Adhesive 18 | 11.2 | 11.2 | | 55.8 | 11.2 | | 3.0 | | | | |
| Adhesive 19 | 11.2 | 11.2 | | 55.8 | 11.2 | | | 3.0 | | | |
| Adhesive 20 | 12.5 | 39.5 | 48.0 | | | | | | | | |
| Adhesive 21 | 12.5 | 39.5 | 48.0 | | | | | | | | |

| | Shrinkage inhibitors | | | | | | |
|---|---|---|---|---|---|---|---|
| | Organometallic compounds | | | | | Photopolymerization | |
| | ORGATIX | ORGATIX | ORGATIX | ORGATIX | ORGATIX | initiator | |
| | TA-10 | TA-30 | TA-21 | TC-750 | TC-100 | IC907 | DETX-S |
| Adhesive 1 | | | | | | 3.0 | 1.5 |
| Adhesive 2 | | | | | | 3.0 | 1.5 |
| Adhesive 3 | | | | | | 3.0 | 1.5 |
| Adhesive 4 | 1.0 | | | | | 3.0 | 1.5 |
| Adhesive 5 | | 1.0 | | | | 3.0 | 1.5 |
| Adhesive 6 | | | 1.0 | | | 3.0 | 1.5 |
| Adhesive 7 | | | | 1.0 | | 3.0 | 1.5 |
| Adhesive 8 | | | | | 0.2 | 3.0 | 1.5 |
| Adhesive 9 | | | | | 4.0 | 2.9 | 1.4 |
| Adhesive 10 | | | | | 10.0 | 2.7 | 1.4 |
| Adhesive 11 | 3.0 | | | | | 3.2 | 1.6 |
| Adhesive 12 | | | 3.0 | | | 3.2 | 1.6 |
| Adhesive 13 | | 3.0 | | | | 3.2 | 1.6 |
| Adhesive 14 | | | | 3.0 | | 3.2 | 1.6 |
| Adhesive 15 | | | | | 3.0 | 3.2 | 1.6 |
| Adhesive 16 | | | | | | 3.2 | 1.6 |
| Adhesive 17 | | | | | | 3.2 | 1.6 |
| Adhesive 18 | | | | | | 3.2 | 1.6 |
| Adhesive 19 | | | | | | 3.2 | 1.6 |
| Adhesive 20 | | | | | | 3.0 | 1.5 |
| Adhesive 21 | | | | | 0.03 | 3.0 | 1.5 |

In Table 1, abbreviations show the following:

HEAA: hydroxyethylacrylamide, manufactured by Kohjin Co., Ltd.;

ACMO: acryloylmorpholine, manufactured by Kohjin Co., Ltd.;

M-220: tripropylene glycol diacrylate (ARONIX M-220), manufactured by Toagosei Co., Ltd.;

1,9-NDA: 1,9 nonadiacrylate, manufactured by Kyoeisha Chemical Co., Ltd.;

UP-1190, manufactured by Toagosei Co., Ltd.;

KBM-602: N-2-(aminoethyl)-3-aminopropylmethyldimethoxysilane, manufactured by Shin-Etsu Chemical Co., Ltd.;

KBM-603: N-2-(aminoethyl)-3-aminopropyltrimethoxysilane, manufactured by Shin-Etsu Chemical Co., Ltd.;

KBM-903: 3-aminopropyltrimethoxysilane, manufactured by Shin-Etsu Chemical Co., Ltd.;

D-20: titanium butoxide (the number of carbon atoms of the organic group: 4), manufactured by a company Shin-Etsu Silicone;

ZA-65: zirconium butoxide (the number of carbon atoms of the organic group: 4), manufactured by Matsumoto Fine Chemical Co., Ltd.;

Aluminum chelate M: alkylacetoacetate diisopropylate (the number of carbon atoms of the organic group: 4 or more), manufactured by Kawaken Fine Chemicals Co., Ltd.;

ORGATIX TA-10: titanium tetraisopropoxide (the number of carbon atoms of the organic group: 3), manufactured by Matsumoto Fine Chemical Co., Ltd.;

TA-30: titanium octoxide (the number of carbon atoms of the organic group: 4), manufactured by Matsumoto Fine Chemical Co., Ltd.;

ORGATIX TA-21: titanium tetra-n-butoxide, manufactured by Matsumoto Fine Chemical Co., Ltd.;

TC-750 (ethyl acetoacetate chelate (the number of carbon atoms of the organic group: 6), manufactured by Matsumoto Fine chemical Co., Ltd.,

TC-100: titanium acetylacetonate (the number of carbon atoms of the organic group: 5), manufactured by Matsumoto Fine Chemical Co., Ltd.;

IC-907: 2-methyl-1-(4-methylthiophenyl)-2-morpholinopropane-1-one, manufactured by the company BASF; and

DETX-S: 2,4-diethyithioxanothone, manufactured by Nippon Kayaku Co., Ltd.

### (Production of Each Polarizing Film)

One of the adhesive compositions described in Table 1 was applied into a thickness of 0.7 μm onto the corona-treated surface of any one of the polarizers, using an MCD coater (manufactured by Fuji Machinery Co., Ltd.) (cell shape: honeycomb, the number of gravure roll lines: 1000/inch, and rotating speed: 140% of the line speed). The resultant workpiece was bonded to any two of the transparent protective films through a roll machine. Thereafter, an active energy ray radiating device was used to radiate the above-mentioned visible rays onto both surfaces of the workpiece from the bonded transparent protective film sides (both sides) of the workpiece to cure the active-energy-ray-curable adhesive. The workpiece was then dried by hot wind at 70° C. for 3 minutes. In this way, each polarizing film used in each of the working examples and the comparative examples was yielded, this film having the transparent protective films, respectively, on both sides of the polarizer. The line speed for the bonding was 25 m/min. In this way, each polarizing film of each of the working examples 1 to 21 and the comparative examples 1 to 3 was yielded.

### (Production of Each Pressure-Sensitive-Adhesive Layer Attached Polarizing Film)

The following were added to a reactor equipped with a condenser, a nitrogen-introducing pipe, a thermometer and a stirrer: 94.9 parts by butyl acrylate, 5 parts of acrylic acid, 0.1 parts of 2-hydroxyehyl acrylate, and dibenzoyl peroxide, the amount of the oxide being 0.3 parts for 100 parts of (solids in) the total of these monomers, together with ethyl acetate. In flowing nitrogen gas, the reactive components in the mixture were caused to react with each other at 60° C. for 7 hours. Thereafter, ethyl acetate was added to the reaction liquid to yield a solution (solid concentration: 30%) containing an acrylic polymer (B) having weight-average molecular weight of 2200000 and a dispersion ratio of 3.9. Into the solution containing the acetic acid polymer (B) were blended trimethylolpropanetolylene diisocyanate (CORONATE L, manufactured by Nippon Polyurethane Industry Co., Ltd.), the amount thereof being 0.6 parts for 100 parts of solids in the solution, and γ-glycidoxypropylmethoxysilane (KBM-403, manufactured by Shin-Etsu Chemical Co., Ltd.), the amount thereof being 0.075 parts therefor. In this way, a pressure-sensitive-adhesive solution was yielded. This solution was diluted with ethyl acetate to give a solid concentration of 15% to prepare a pressure-sensitive-adhesive applying solution. The thus-prepared pressure-sensitive-adhesive applying solution was applied into an applying thickness of 134.0 μm onto a 38-μm-thick polyethylene terephthalate (PET) film (MRF 38, manufactured by Mitsubishi Polyester Film, Ltd.), using a fountain die coater. Next, the workpiece was dried at 155° C. for one minute to form a 20-μm-thick pressure-sensitive-adhesive layer. The pressure-sensitive-adhesive layer was transferred onto any one of the polarizing films as described above. In this way, each pressure-sensitive-adhesive layer attached polarizing film of each of the working examples 1 to 21 and the comparative examples 1 to 3 was yielded.

Evaluations described below were made about the pressure-sensitive-adhesive layer attached polarizing films yielded in each of the working examples and the comparative examples. Results of the evaluations are shown in Table 1.

<PVA Shrinkage after Immersion in Hot Water>

One of the resultant pressure-sensitive-adhesive layer attached polarizing films was cut into a size of 200 mm in a direction parallel with the stretched direction of the polarizer, and 15 mm in a direction orthogonal thereto. The cut film was caused to adhere onto a glass plate. The film was immersed in hot water of 60° C. temperature for six hours in the state of adhering to the glass plate. After the six hours from the immersion, the glass plate was taken out from the hot water, and the shrinkage quantity of the PVA was measured with a measuring ruler at a portion thereof where the quantity was the largest. After the glass plate was taken out, a case where the shrinkage percentage was more than 5 mm was judged to be bad (cross mark); a case where the percentage was more than 2.5 mm and 5 mm or less was judged to be acceptable (triangular mark); or a case where the shrinkage percentage was 2.5 mm or less was judged to be good (circular mark).

### <Storage Stability of Each Adhesive>

In each of the examples, the individual components were blended with each other in accordance with a blend table described in Table 1. The blend was stirred, and then stored for one week. A case where no precipitation was produced in the adhesive was judged to be good (circular mark); or a case where a precipitation was produced therein was judged to be bad (cross mark).

TABLE 2

| | | | | | | PVA shrinkage | |
|---|---|---|---|---|---|---|---|
| | PVA | | Maximum dimension | Activating | | after PVA | Storage |
| | polarizer | PVA | change ratio of | treatment of | Adhesive | immersion in | stability of |
| | species | thickness | polarizing film | polarizer | species | hot water | adhesive |
| Example 1 | 1 | 18 | 0.38 | Conducted | 1 | ∘ | ∘ |
| Example 2 | 1 | 18 | 0.38 | Conducted | 2 | ∘ | x |
| Example 3 | 1 | 18 | 0.38 | Conducted | 3 | ∘ | x |
| Example 4 | 1 | 18 | 0.38 | Conducted | 4 | ∘ | ∘ |
| Example 5 | 1 | 18 | 0.38 | Conducted | 5 | ∘ | ∘ |
| Example 6 | 1 | 18 | 0.38 | Conducted | 6 | ∘ | ∘ |
| Example 7 | 1 | 18 | 0.38 | Conducted | 7 | ∘ | ∘ |
| Example 8 | 1 | 18 | 0.38 | Conducted | 8 | ∘ | ∘ |
| Example 9 | 1 | 18 | 0.38 | Conducted | 9 | ∘ | ∘ |
| Example 10 | 1 | 18 | 0.38 | Conducted | 10 | ∘ | x |
| Example 11 | 2 | 5 | 0.18 | Conducted | 11 | ∘ | ∘ |
| Example 12 | 2 | 5 | 0.18 | Conducted | 12 | ∘ | ∘ |
| Example 13 | 2 | 5 | 0.18 | Conducted | 13 | ∘ | ∘ |
| Example 14 | 2 | 5 | 0.18 | Conducted | 14 | ∘ | ∘ |
| Example 15 | 2 | 5 | 0.18 | Conducted | 15 | ∘ | ∘ |
| Example 16 | 2 | 5 | 0.18 | Conducted | 16 | ∘ | ∘ |
| Example 17 | 2 | 5 | 0.18 | Conducted | 17 | ∘ | ∘ |
| Example 18 | 2 | 5 | 0.18 | Conducted | 18 | ∘ | ∘ |
| Example 19 | 2 | 5 | 0.18 | Conducted | 19 | ∘ | ∘ |
| Example 20 | 1 | 18 | 0.38 | Conducted | 21 | Δ | ∘ |
| Comparative | 1 | 18 | 0.38 | Conducted | 20 | x | ∘ |
| Example 1 | | | | | | | |
| Comparative | 1 | 18 | 0.38 | Not conducted | 4 | x | ∘ |
| Example 2 | | | | | | | |
| Comparative | 3 | 23 | 0.42 | Conducted | 13 | x | ∘ |
| Example 3 | | | | | | | |

1. A pressure-sensitive-adhesive layer attached polarizing film, comprising a polarizing film in which a transparent protective film is laid on/over at least one surface of a polarizer to interpose an adhesive layer between the surface and the transparent protective film; and
a pressure-sensitive-adhesive layer laminated on a transparent protective film side of the polarizing film;
wherein the adhesive-layer-laid surface of the polarizer is subjected to an activating treatment;
the adhesive layer is a cured product layer of an adhesive composition;
the adhesive composition comprises an active-energy-ray-curable component, and a shrinkage inhibitor having a structural formula having an M-O bond wherein M is silicon, titanium, aluminum or zirconium, and O represents an oxygen atom; and
a maximum dimension change ratio defined by the following is 0.40% or less:
“maximum dimension change ratio”=“a maximum dimension change ratio out of respective dimension change ratios in an MD direction and a TD direction of the pressure-sensitive-adhesive layer attached polarizing film, these ratios being measured after the pressure-sensitive-adhesive layer attached polarizing film is allowed to stand still in an environment of 80° C. temperature for 500 hours, and respective dimension change ratios in the MD direction and the TD direction of the pressure-sensitive-adhesive layer attached polarizing film, these ratios being measured after the pressure-sensitive-adhesive layer attached polarizing film is allowed to stand still in an environment of 60° C. temperature and 90% humidity for 500 hours”.

2. The pressure-sensitive-adhesive layer attached polarizing film according to claim 1, wherein the shrinkage inhibitor is an organosilicon compound.

3. The pressure-sensitive-adhesive layer attached polarizing film according to claim 1, wherein the shrinkage inhibitor is at least one organometallic compound selected from the group consisting of metal alkoxides, and metal chelates.

4. The pressure-sensitive-adhesive layer attached polarizing film according to claim 3, wherein the organometallic compound is at least one selected from the group consisting of titanium acylates, titanium alkoxides, and titanium chelates.

5. The pressure-sensitive-adhesive layer attached polarizing film according to claim 1, wherein when a total amount of the active-energy-ray-curable component is regarded as 100 parts by weight, a proportion of the shrinkage inhibitor is from 0.05 to 9 parts by weight.

6. The pressure-sensitive-adhesive layer attached polarizing film according to claim 1, wherein the shrinkage inhibitor comprises an organic group, and the organic group has 3 or more carbon atoms.

7. The pressure-sensitive-adhesive layer attached polarizing film according to claim 1, wherein the transparent protective film has a moisture permeability of 5 to 70 g/m².

8. The pressure-sensitive-adhesive layer attached polarizing film according to claim 1, wherein the polarizing film has a thickness of 100 μm or less.

9. A method for producing a pressure-sensitive-adhesive layer attached polarizing film, comprising a polarizing film in which a transparent protective film is laid on/over at least one surface of a polarizer to interpose an adhesive layer between the surface and the transparent protective film, and a pressure-sensitive-adhesive layer laminated on a transparent protective film side of the polarizing film; comprising the following:
a step of subjecting an adhesive-layer-laying-planned surface of the polarizer to an activating treatment;
an applying step of applying an adhesive composition comprising an active-energy-ray-curable component, and a shrinkage inhibitor having a structural formula having an M-O bond wherein M is silicon, titanium, aluminum or zirconium, and O represents an oxygen atom to a surface of at least one of the polarizer and the transparent protective film;
a bonding step of bonding the polarizer and the transparent protective film to each other;
an adhering step of radiating an active energy ray to the resultant workpiece from a polarizer surface side of the workpiece or a transparent protective film surface side of the workpiece to cure the adhesive composition to yield the adhesive layer, and causing the polarizer and the transparent protective film to adhere to each other through the yielded adhesive layer; and
a step of forming the pressure-sensitive-adhesive layer on/over a surface of the transparent protective film that is opposite to the adhesive-layer-laminated surface of the transparent protective film.

10. The method for producing a pressure-sensitive-adhesive layer attached polarizing film according to claim 9, wherein the shrinkage inhibitor is an organosilicon compound.

11. The method for producing a pressure-sensitive-adhesive layer attached polarizing film according to claim 9, wherein the shrinkage inhibitor is at least one organometallic compound selected from the group consisting of metal alkoxides, and metal chelates.
